(19) United States
(12) Patent Application Publication
(10) Pub. No.: US 2025/0193735 A1
(43) Pub. Date: Jun. 12, 2025

(54) TECHNIQUES FOR HANDLING SERVICE DATA ADAPTATION PROTOCOL (SDAP) HEADERS WITH PACKET DATA CONVERGENCE PROTOCOL (PDCP) CONCATENATION

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US)

(21) Appl. No.: 18/536,012

(22) Filed: Dec. 11, 2023

(51) Int. Cl. H04W 28/06

(52) U.S. Cl. CPC H04W 28/065

(57) ABSTRACT

Methods, systems, and devices for wireless communications are described, including techniques for handling service data adaptation protocol (SDAP) headers with packet data convergence protocol (PDCP) concatenation. A first wireless device may identify different portions of a protocol data unit (PDU), where a first portion that includes one or more SDAP headers and a second portion includes a concatenated service data unit (SDU) that includes a set of multiple SDUs. The first wireless device may cipher the concatenated SDU based on the concatenated SDU being separate from the one or more SDAP headers, such that the SDAP headers are left unciphered. The first wireless device may then transmit one or more messages to a second wireless device which includes the ciphered PDU with the one or more unciphered SDAP headers and the ciphered concatenated SDU.

### FIELD OF TECHNOLOGY

The following relates to wireless communications, including techniques for handling service data adaptation protocol (SDAP) headers with packet data convergence protocol (PDCP) concatenation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications devices may process data for communications (e.g., transmission or reception) according to one or more layers of a protocol stack, each of which may be associated with various functionalities. For example, the protocol stack may include a packet data convergence protocol (PDCP) layer, which may support integrity protection, ciphering, or both on data packets received at the PDCP layer.

### SUMMARY

The described techniques relate to improved methods, systems, devices, and apparatuses that support techniques for handling service adaptation protocol (SDAP) headers with packet data convergence protocol (PDCP) concatenation. For example, the described techniques provide for efficient handling of PDCP headers and SDAP control protocol data units (PDUs) located within a PDCP PDU. For example, a transmitting wireless device may identify one or more different configured locations for placement of SDAP headers and SDAP control PDUs within a PDCP PDU. In such examples, the transmitting wireless device may place the SDAP headers and the SDAP control PDUs such that the SDAP headers and the SDAP control PDUs do not undergo ciphering, and such that the location of the SDAP headers and the SDAP control PDUs reduce ciphering complexity at the transmitting wireless device, as well as deciphering complexity at the receiving wireless device.

The transmitting wireless device may identify different portions of the PDU, where a first portion that includes the one or more SDAP headers and a second portion includes a concatenated SDU that includes a set of multiple SDUs. The transmitting wireless device may cipher the concatenated SDU based on the concatenated SDU being separate from the one or more SDAP headers, such that the SDAP headers are left unciphered. The transmitting wireless device may transmit one or more messages to a receiving wireless device which includes the ciphered PDU with the one or more unciphered SDAP headers and the ciphered concatenated SDU.

A method for wireless communications by a first wireless device is described. The method may include identifying a first portion and a second portion of a PDU, the first portion including one or more SDAP headers and the second portion including a concatenated SDU that includes a set of multiple SDUs, ciphering the concatenated SDU based on the concatenated SDU being separate from the one or more SDAP headers, and transmitting, to a second wireless device, one or more messages including the PDU including the one or more SDAP headers and the ciphered concatenated SDU.

A first wireless device for wireless communications is described. The first wireless device may include one or more memories storing processor-executable code, and one or more processors coupled with the one or more memories. The one or more processors may individually or collectively operable to execute the code to cause the first wireless device to identify a first portion and a second portion of a PDU, the first portion including one or more SDAP headers and the second portion including a concatenated SDU that includes a set of multiple SDUs, cipher the concatenated SDU based on the concatenated SDU being separate from the one or more SDAP headers, and transmit, to a second wireless device, one or more messages including the PDU including the one or more SDAP headers and the ciphered concatenated SDU.

Another first wireless device for wireless communications is described. The first wireless device may include means for identifying a first portion and a second portion of a PDU, the first portion including one or more SDAP headers and the second portion including a concatenated SDU that includes a set of multiple SDUs, means for ciphering the concatenated SDU based on the concatenated SDU being separate from the one or more SDAP headers, and means for transmitting, to a second wireless device, one or more messages including the PDU including the one or more SDAP headers and the ciphered concatenated SDU.

A non-transitory computer-readable medium storing code for wireless communications is described. The code may include instructions executable by one or more processors to identify a first portion and a second portion of a PDU, the first portion including one or more SDAP headers and the second portion including a concatenated SDU that includes a set of multiple SDUs, cipher the concatenated SDU based on the concatenated SDU being separate from the one or more SDAP headers, and transmit, to a second wireless device, one or more messages including the PDU including the one or more SDAP headers and the ciphered concatenated SDU.

In some examples of the method, first wireless devices, and non-transitory computer-readable medium described herein, the one or more SDAP headers may be included as part of one or more respective concatenation headers of the PDU and the one or more SDAP headers and the one or more respective concatenation headers may be unciphered based on the concatenated SDU being separate from the one or more SDAP headers and the one or more respective concatenation headers.

In some examples of the method, first wireless devices, and non-transitory computer-readable medium described herein, a first SDAP header of the one or more SDAP headers may be adjacent to a first SDU of the set of multiple SDUs and a second SDAP header of the one or more SDAP headers may be adjacent to a second SDU of the set of multiple SDUs and the one or more SDAP headers may be cyphered or uncyphered based on the ciphering of the concatenated SDU.

In some examples of the method, first wireless devices, and non-transitory computer-readable medium described herein, the one or more SDAP headers include a SDAP control PDU and the method, first wireless devices, and non-transitory computer-readable medium may include further operations, features, means, or instructions for outputting, to a concatenation buffer, the set of multiple SDUs with the SDAP control PDU.

In some examples of the method, first wireless devices, and non-transitory computer-readable medium described herein, the one or more SDAP headers include a SDAP control PDU and the method, first wireless devices, and non-transitory computer-readable medium may include further operations, features, means, or instructions for outputting the SDAP control PDU for transmission to the second wireless device, where the SDAP control PDU may be excluded from concatenation with the set of multiple SDUs.

Some examples of the method, first wireless devices, and non-transitory computer-readable medium described herein may further include operations, features, means, or instructions for skipping addition of the SDAP control PDU to concatenation buffer for obtaining the concatenated SDU and applying the SDAP control PDU for transmission to the second wireless device after addition of a PDCP header.

In some examples of the method, first wireless devices, and non-transitory computer-readable medium described herein, the one or more SDAP headers include a SDAP control PDU and the method, first wireless devices, and non-transitory computer-readable medium may include further operations, features, means, or instructions for outputting the concatenated SDU from a concatenation buffer based on detecting the SDAP control PDU among the set of multiple SDUs and outputting, for transmission to the second wireless device, the SDAP control PDU with the set of multiple SDUs of the concatenated SDU.

In some examples of the method, first wireless devices, and non-transitory computer-readable medium described herein, outputting the concatenated SDU from the concatenation buffer may include operations, features, means, or instructions for outputting the concatenated SDU from the concatenation buffer irrespective of whether a quantity of the set of multiple SDUs satisfies a threshold quantity, whether a concatenation timer may be expired, or both, in response to detecting the SDAP control PDU.

In some examples of the method, first wireless devices, and non-transitory computer-readable medium described herein, the one or more SDAP headers include a SDAP control PDU and the method, first wireless devices, and non-transitory computer-readable medium may include further operations, features, means, or instructions for outputting the PDU for transmission to the second wireless device, where the SDAP control PDU may be included as part of a respective concatenation header of the PDU, and where the SDAP control PDU and the respective concatenation header occur prior to the concatenated SDU.

In some examples of the method, first wireless devices, and non-transitory computer-readable medium described herein, the respective concatenation header includes a length field that indicates a payload size of the SDAP control PDU.

In some examples of the method, first wireless devices, and non-transitory computer-readable medium described herein, the payload size including a value of zero indicates a presence of the SDAP control PDU.

In some examples of the method, first wireless devices, and non-transitory computer-readable medium described herein, the PDU includes a PDCP PDU, a PDCP control PDU, one or more robust header compression (ROHC) PDUs, one or more ethernet header compression (EHC) PDUs, or any combination thereof.

A method for wireless communications by a first wireless device is described. The method may include receiving a PDU including a first portion and a second portion, the first portion including one or more unciphered SDAP headers and the second portion including a ciphered concatenated SDU that includes a set of multiple SDUs and deciphering the second portion of the PDU based on the ciphered concatenated SDU being separate from the one or more unciphered SDAP headers.

A first wireless device for wireless communications is described. The first wireless device may include one or more memories storing processor-executable code, and one or more processors coupled with the one or more memories. The one or more processors may individually or collectively operable to execute the code to cause the first wireless device to receive a PDU including a first portion and a second portion, the first portion including one or more unciphered SDAP headers and the second portion including a ciphered concatenated SDU that includes a set of multiple SDUs and decipher the second portion of the PDU based on the ciphered concatenated SDU being separate from the one or more unciphered SDAP headers.

Another first wireless device for wireless communications is described. The first wireless device may include means for receiving a PDU including a first portion and a second portion, the first portion including one or more unciphered SDAP headers and the second portion including a ciphered concatenated SDU that includes a set of multiple SDUs and means for deciphering the second portion of the PDU based on the ciphered concatenated SDU being separate from the one or more unciphered SDAP headers.

A non-transitory computer-readable medium storing code for wireless communications is described. The code may include instructions executable by one or more processors to receive a PDU including a first portion and a second portion, the first portion including one or more unciphered SDAP headers and the second portion including a ciphered concatenated SDU that includes a set of multiple SDUs and decipher the second portion of the PDU based on the ciphered concatenated SDU being separate from the one or more unciphered SDAP headers.

In some examples of the method, first wireless devices, and non-transitory computer-readable medium described herein, the one or more SDAP headers may be included as part of one or more respective concatenation headers of the PDU and the one or more SDAP headers and the one or more respective concatenation headers may be unciphered based on the concatenated SDU being separate from the one or more SDAP headers and the one or more respective concatenation headers.

In some examples of the method, first wireless devices, and non-transitory computer-readable medium described herein, a first SDAP header of the one or more SDAP headers may be adjacent to a first SDU of the set of multiple concatenated SDUs and a second SDAP header of the one or more SDAP headers may be adjacent to a second SDU of the set of multiple concatenated SDUs.

In some examples of the method, first wireless devices, and non-transitory computer-readable medium described herein, the one or more unciphered SDAP headers each include an unciphered SDAP control PDU and the unciphered SDAP control PDU may be separate from the ciphered concatenated SDU.

In some examples of the method, first wireless devices, and non-transitory computer-readable medium described herein, the unciphered SDAP control PDU may be included as part of a respective concatenation header of the PDU and the unciphered SDAP control PDU and the respective concatenation header occur prior to the set of multiple ciphered concatenated SDUs.

In some examples of the method, first wireless devices, and non-transitory computer-readable medium described herein, the respective concatenation header includes a length field that indicates a payload size of the unciphered SDAP control PDU.

Some examples of the method, first wireless devices, and non-transitory computer-readable medium described herein may further include operations, features, means, or instructions for identifying a first unciphered SDAP control PDU based on a payload size of a first length field including a value of zero.

In some examples of the method, first wireless devices, and non-transitory computer-readable medium described herein, the PDU includes a PDCP PDU, a PDCP control PDU, one or more ROHC PDUs, one or more EHC PDUs, or any combination thereof.

### BRIEF DESCRIPTION OF THE DRAWINGS

FIG. 1 shows an example of a wireless communications system that supports techniques for handling service data adaptation protocol (SDAP) headers with packet data convergence protocol (PDCP) concatenation in accordance with one or more aspects of the present disclosure.

FIG. 2 shows an example of a PDCP concatenation configuration that supports techniques for handling SDAP headers with PDCP concatenation in accordance with one or more aspects of the present disclosure.

FIG. 3 shows an example of SDAP header placement configurations that support techniques for handling SDAP headers with PDCP concatenation in accordance with one or more aspects of the present disclosure.

FIGS. 4, 5, and 6 show example SDAP control PDU placement configurations that support techniques for handling SDAP headers with PDCP concatenation in accordance with one or more aspects of the present disclosure.

FIG. 7 shows an example of a process flow that supports techniques for handling SDAP headers with PDCP concatenation in accordance with one or more aspects of the present disclosure.

FIGS. 8 and 9 show block diagrams of devices that support techniques for handling SDAP headers with PDCP concatenation in accordance with one or more aspects of the present disclosure.

FIG. 10 shows a block diagram of a communications manager that supports techniques for handling SDAP headers with PDCP concatenation in accordance with one or more aspects of the present disclosure.

FIG. 11 shows a diagram of a system including a UE that supports techniques for handling SDAP headers with PDCP concatenation in accordance with one or more aspects of the present disclosure.

FIG. 12 shows a diagram of a system including a network entity that supports techniques for handling SDAP headers with PDCP concatenation in accordance with one or more aspects of the present disclosure.

FIGS. 13 through 16 show flowcharts illustrating methods that support techniques for handling SDAP headers with PDCP concatenation in accordance with one or more aspects of the present disclosure.

### DETAILED DESCRIPTION

In some wireless communications systems, a transmitting wireless device (such as a user equipment (UE) or a network entity) may process data for transmission according to one or more layers of a protocol stack (such as a control plane protocol stack or a user plane protocol stack), which may include a packet data convergence protocol (PDCP) layer. The PDCP layer may support transferring data (via protocol data units (PDUs)) by performing ciphering and integrity protection on the data, applying a PDCP header to the data, and outputting the data via a PDCP PDU for transmission to a receiving wireless device. Inputs of the PDCP layer (e.g., from another protocol layer) may be referred to as service data units (SDUs) or PDCP SDUs, and the transmitting wireless device may perform PDCP layer processing (e.g., integrity protection and ciphering) on each SDU that is input into the PDCP layer or on sets of concatenated SDUs. In some cases, however, the positioning of one or more PDCP headers within the PDCP PDU relative to the concatenated SDUs may result in challenges for integrity protection and ciphering for the concatenated SDUs, because the PDCP headers (including service data adaptation protocol (SDAP) headers) should not undergo ciphering. Similar challenges may arise for the positioning of one or more SDAP control PDUs within the PDCP PDU, as it may be desirable to refrain from ciphering of some SDAP PDUs.

To support efficient handling of PDCP headers and SDAP control PDUs located within a PDCP PDU, a transmitting wireless device may identify one or more different configured locations for placement of SDAP headers and SDAP control PDUs within a PDCP PDU. For example, the transmitting wireless device may place the SDAP headers and the SDAP control PDUs such that the SDAP headers and the SDAP control PDUs do not undergo ciphering, and such that the location of the SDAP headers and the SDAP control PDUs reduce ciphering complexity at the transmitting wireless device and deciphering complexity at the receiving wireless device.

In one example, the SDAP headers are placed at the beginning of the concatenated SDUs as part of a concatenation header, such that the transmitting wireless device may skip concatenation for the SDAP headers and the concatenation header, and perform concatenation on the following SDUs. In another example, the SDAP control PDU is not concatenated with any SDUs, and instead skips a concatenation buffer step and is forwarded directly to the radio link control for transmission. In another example, the presence of an SDAP control PDU triggers a forwarding of the concatenated SDUs already present in the concatenation buffer (e.g., the SDAP control PDU force empties the SDU concatenation buffer) for transmission, which preserves the ordering of the SDUs and the SDAP control PDU. In another example, the SDAP control PDU is placed at the beginning of the concatenated SDU as part of a concatenation header, such that the transmitting wireless device may skip concatenation for the concatenation header and the SDAP control PDU, and perform concatenation on the following SDUs.

Aspects of the disclosure are initially described in the context of wireless communications systems. Aspects of the disclosure are further illustrated by and described with reference to PDCP concatenation configurations, SDAP header placement configurations, SDAP control PDU placement configurations, a process flow, apparatus diagrams, system diagrams, and flowcharts that relate to techniques for handling SDAP headers with PDCP concatenation.

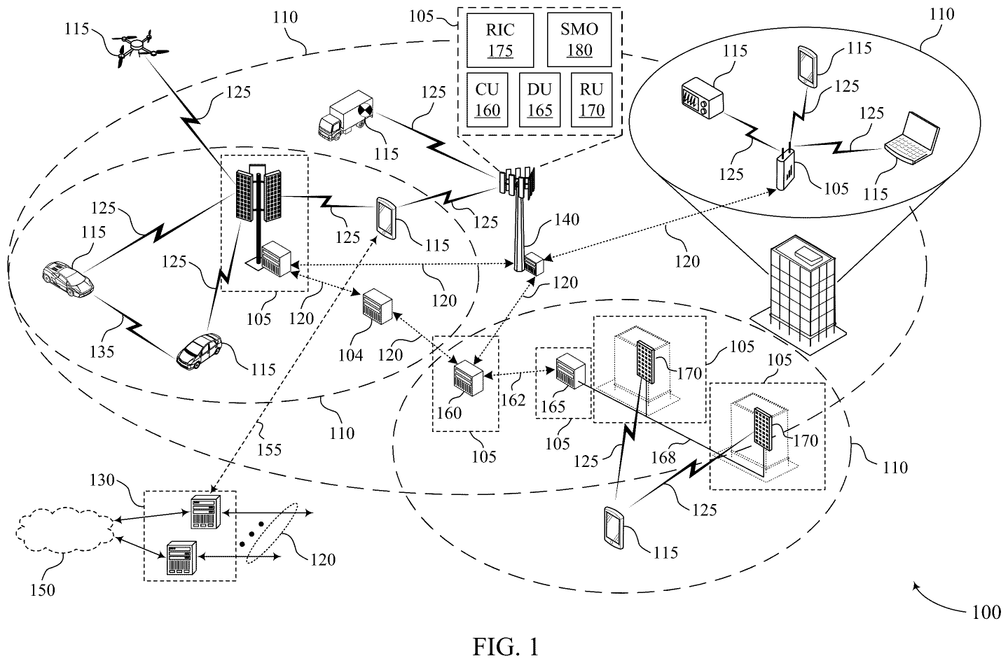

FIG. 1 shows an example of a wireless communications system 100 that supports techniques for handling SDAP headers with PDCP concatenation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for handling SDAP headers with PDCP concatenation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a transmitting wireless device (e.g., a network entity 105, a UE 115) may process data for transmission according to one or more layers of a protocol stack as described herein. For example, the transmitting wireless device may support L2 functionality and signaling, which may include PDCP (or SDAP) functions, voice over internet protocol (VoIP), non-terrestrial network (NTN) implementations, among other deployments. The transmitting wireless device may identify SDUs at the PDCP layer (e.g., protocol data units (PDUs) received from a previous layer, such as an RRC layer) and may perform one or more PDCP functions on the SDUs. For example, the transmitting wireless device may perform integrity protection on PDCP SDUs, such as by a user plane integrity protection (UPIP) function or other security algorithm-based invocations, which may support the transmitting wireless device communicating at a desired data rate (e.g., UPIP may be mandatory for the transmitting wireless device to maintain a full data rate). In some examples, signaling overhead may be reduced by adding PDCP, RLC, and MAC headers for each SDU communicated in the system. In some cases, however, a throughput of the transmitting wireless device may be associated with (e.g., limited by) a quantity of the SDUs due to performing PDCP layer functions on each SDU individually. For example, some functions (e.g., cryptographic processing) may include initialization and security key setup procedures, and the transmitting wireless device may communicate with hardware accelerators at a relatively high rate (e.g., increasing a load on hardware even if the hardware is capable of supporting larger SDU sizes).

To reduce latency associated with individually processing PDCP SDUs, a transmitting wireless device may concatenate one or more sets of SDUs and may perform PDCP processing on the concatenated SDUs. A concatenated SDU, as described herein, may refer to a set of multiple SDUs that are concatenated together. For example, the transmitting wireless device may input a set of multiple SDUs to a concatenation buffer at the PDCP layer, which may concatenate the multiple SDUs into a single concatenated SDU (e.g., a pseudo SDU including each SDU input to the concatenation buffer). Additionally, or alternatively, the multiple concatenation buffers may be configured to concatenate SDUs according to a RLC entity, a QoS flow, or both associated with the SDUs (e.g., the transmitting wireless device may route SDUs to a concatenation buffers according to RLC entity and QoS flow). By implementing multiple concatenation buffers at the PDCP layer, latency, processing time, and overhead associated with PDCP processing may be reduced, thereby improving a throughput of the transmitting wireless device. Additionally, or alternatively, SDU concatenation may reduce hardware burden at wireless devices within the wireless communications system 100, such that the hardware performs user plane integrity protection and ciphering for each group of concatenated SDUs, rather than for each individual SDU.

In some cases, however a transmitting wireless device such as a UE 115 may experience challenges when performing protection and ciphering for a group of concatenated SDUs that include PDCP headers, SDAP control PDUs, or both, located within the concatenated SDUs, because both the PDCP headers and the SDAP control PDUs should not undergo ciphering. To support efficient handling of PDCP headers and SDAP control PDUs located within a PDCP PDU, a transmitting wireless device may identify one or more different configured locations for placement of SDAP headers and SDAP control PDUs within a PDCP PDU. For example, the transmitting wireless device may place the SDAP headers and the SDAP control PDUs such that the SDAP headers and the SDAP control PDUs do not undergo ciphering.

In one example configuration, the SDAP headers may be placed at the beginning of the concatenated SDUs as part of a concatenation header. In another example configuration, the SDAP control PDU is not concatenated with any SDUs, and instead skips a concatenation buffer step and is forwarded directly to the radio link control for transmission. In another example configuration, the presence of an SDAP control PDU triggers a forwarding of the concatenated SDUs already present in the concatenation buffer (e.g., the SDAP control PDU force empties the SDU concatenation buffer) for transmission, which preserves the ordering of the SDUs and the SDAP control PDU. In another example configuration, the SDAP control PDU is placed at the beginning of the concatenated SDU as part of a concatenation header.

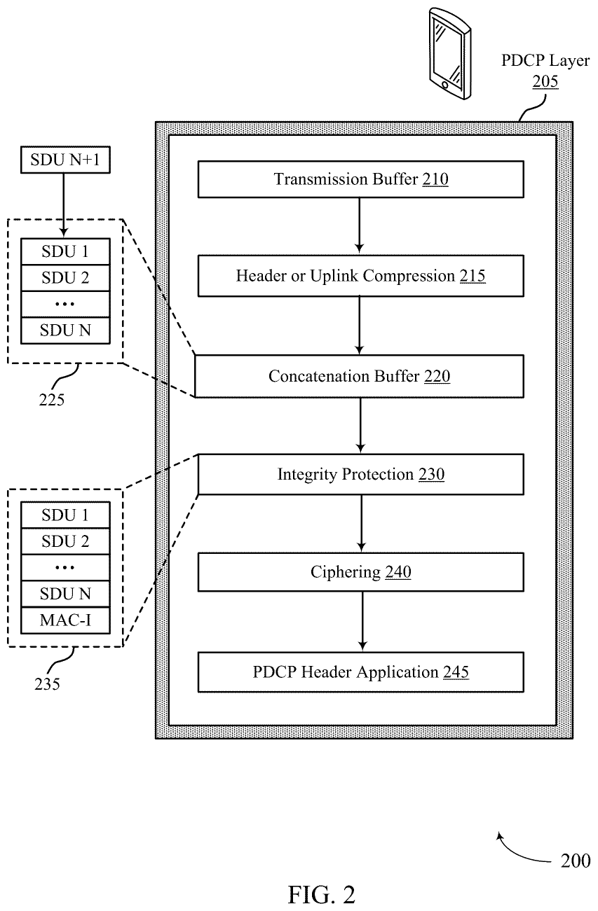

FIG. 2 shows an example of a PDCP concatenation configuration 200 that supports techniques for handling SDAP headers with PDCP concatenation in accordance with one or more aspects of the present disclosure. The PDCP concatenation configuration 200 may implement, or be implemented by, one or more aspects of the wireless communications systems 100. For example, the PDCP concatenation configuration 200 shows functionality associated with a PDCP layer at a transmitting wireless device, which may be an example of a UE 115 or a network entity 105 described with reference to FIG. 1.

In some cases, a transmitting wireless device may identify one or more SDUs at the PDCP layer 205, which may include data for transmission to a receiving wireless device. For example, the transmitting wireless device may receive the SDUs from a different or higher layer of the protocol stack (e.g., an RRC layer, an SDAP layer, or the like), which may be initially stored in a transmission buffer 210. In some cases, the transmitting wireless device may perform sequence numbering to order the SDUs (e.g., numerically, relationally) in the transmission buffer 210. For example, the transmitting wireless device may apply a first sequence number (SN) (e.g., SN 1) to a first SDU in the transmission buffer 210, may apply a second SN (e.g., SN 2) to a second SDU in the transmission buffer 210, and so on. After storing the one or more SDUs in the transmission buffer 210, the transmitting wireless device may apply header compression or uplink compression 215 to the ordered SDUs in the transmission buffer 210. In some examples, the transmitting wireless device may perform header compression or uplink data compression to the SDUs in order to reduce a relative size of the SDUs (e.g., to conserve radio resources and signaling overhead). For example, if a size of a header of an SDU is relatively large compared to a data portion of the SDU, the transmitting wireless device may apply header compression to the SDU (e.g., via robust header compression (ROHC)). Additionally, or alternatively, if the SDUs are associated with uplink data, the transmitting wireless device may apply an uplink data compression function (which may be preconfigured for a data radio bearer (DRB)) to the SDUs.

In some examples, the transmitting wireless device may route the SDUs into one or more concatenation buffers 220, which may concatenate the multiple SDUs into a single concatenated SDU 225. For example, the transmitting wireless device may use the one or more concatenation buffers 220 to obtain a first concatenated SDU 225, which may include a concatenation of multiple SDUs (e.g., SDU 1 through SDU N, where N may be any integer value). It should be noted that the transmitting wireless device may support any quantity of concatenation buffers and is not limited to the quantity illustrated by the PDCP concatenation configuration 200.

For example, the transmitting wireless device may input SDUs into the one or more concatenation buffers 220 until one or more parameters are satisfied, such as a concatenation timer expiring (e.g., t>concatenationTimer), a threshold concatenated SDU size being reached (e.g., SDU size>maxSDUSize), or both. In some examples, the concatenation timer may be set according to a threshold (e.g., maximum) allowable delay of the radio bearer or quality of service (QoS) flow, or may be set based on device implementation. In some examples, the threshold (e.g., maximum) SDU size may be determined based on device implementation or may be set according to a combination of factors including UE capability indicated by UE or network considerations (such as a lower bound on a grant size, channel occupancy time (COT) in an unlicensed band), among other factors. In some examples, the one or more concatenation buffers 220 may maintain a threshold concatenated SDU size (e.g., Concatenated_SDU_Size), which may be indicative of a cumulative size of data (e.g., bytes) of the total quantity of SDUs in the one or more concatenation buffers 220.

In some examples, the one or more concatenation buffers 220 may be configured with a first duration value for concatenating SDUs and a first threshold size associated with the first concatenated SDU 225. In such an example, the transmitting wireless device may initiate a concatenation timer after inputting a first SDU (e.g., SDU 1) to the one or more concatenation buffers 220 and may input one or more subsequent SDUs (e.g., SDU 2 through SDU N) to the one or more concatenation buffers 220 until the concatenation timer elapses (e.g., a duration of the timer exceeds the first duration value). Otherwise, if the concatenation timer has not elapsed, the transmitting wireless device may maintain a size of the first concatenated SDU 225 (e.g., Concatenated_SDU_Size) in the one or more concatenation buffers 220, and may compare the size to the first threshold size after adding each SDU to the concatenated SDU 225. For example, when a new SDU arrives to the one or more concatenation buffers 220 (e.g., SDU N+1), the transmitting wireless device may determine whether the size of the concatenated SDU 225 including the new SDU exceeds the first threshold size (e.g., whether new SDU size+Concatenated_SDU_Size>maxSDUSize).

In a first example, if the concatenated SDU 225 including the new SDU does exceed the first threshold size, the transmitting wireless device may forward the content of the one or more concatenation buffers 220 (e.g., without the SDU N+1) as a single concatenated SDU 225, may flush the one or more concatenation buffers 220 (e.g., empty the one or more concatenation buffers 220), and may input the new SDU into the one or more concatenation buffers 220 (e.g., setting Concatenated_SDU_Size=new SDU size). In such examples, the transmitting wireless device may stop and restart the concatenation timer for the one or more concatenation buffers 220 based on forwarding the content of the one or more concatenation buffers 220. In a second example, if the concatenated SDU 225 including the new SDU does not exceed the first threshold size, the transmitting wireless device may add the new SDU to the one or more concatenation buffers 220 and may update the size of the concatenated SDU 225 (e.g., Concatenated_SDU_Size=Concatenated_SDU_Size+new SDU size).

In some cases, the transmitting wireless device may perform one or more PDCP layer functions on the one or more concatenated SDUs 225. For example, the transmitting wireless device may perform integrity protection 230 on the one or more concatenated SDUs to verify the concatenated SDUs, and may apply a message authentication code integrity (MAC-I) field to each concatenated SDU verified via the integrity protection 230, to form a set of authenticated SDUs. Additionally, the transmitting wireless device may perform ciphering 240 on the one or more concatenated SDUs to prepare the concatenated SDUs for transmission to a receiving wireless device (e.g., encoding data associated with the concatenated SDUs). In some cases, performing the PDCP layer 205 functions (e.g., integrity protection 235 and ciphering 240) on the concatenated SDUs instead of on each individual SDU may reduce a quantity and frequency of hardware invocations at the transmitting and/or receiving wireless device, overhead associated with the PDCP layer 205 (e.g., UPIP overhead), latency associated with processing data (e.g., cryptographic processing time), or any combination thereof, among other benefits.

In some examples, after performing the PDCP layer 205 functions on the one or more concatenated SDUs, the transmitting wireless device may perform PDCP header application 245 to the one or more concatenated SDUs. Alternatively, the transmitting wireless device may perform PDCP header application 245 to one or more SDUs following the header or uplink compression 215 (e.g., without routing the SDUs through the one or more concatenation buffers 220, the integrity protection 230, and the ciphering 240). In some cases, adding a PDCP header to an SDU may convert the SDU into a PDCP PDU. For example, the one or more concatenated SDUs may become one or more concatenated PDUs after PDCP header application 245. In some examples, the transmitting wireless device may perform routing and duplication on the one or more concatenated PDUs based on adding the PDCP headers, which may route the PDCP PDUs to an intended radio bearer and duplication of PDCP PDUs for transmission to different radio bearers (e.g., if a split bearer configuration is enabled).

In some cases, the transmitting wireless device may transmit one or more messages including the one or more concatenated PDUs to a receiving wireless device via a Uu or PC5 radio interface. In some examples, the transmitting wireless device may perform additional processing on the concatenated PDUs according to one or more subsequent layers of the protocol stack, such as an RLC layer and a MAC layer, before transmitting the one or more messages via a PHY layer (e.g., the Uu or PC5 radio interface). In some cases, the receiving wireless device may process and decode the one or more concatenated PDUs according to functions of the PDCP layer 205. For example, the receiving wireless device may remove PDCP headers from the one or more concatenated PDUs to obtain one or more concatenated SDUs (e.g., the concatenated SDUs output from the one or more concatenation buffers 220). The receiving wireless device may then decode the one or more concatenated SDUs by performing deciphering (e.g., an inverse of the ciphering 240) and may verify the one or more concatenated SDUs by performing integrity verification (e.g., confirming the MAC-I field output from the integrity protection 230). In some examples, the receiving wireless device may input the decoded concatenated SDUs into a reception buffer to separate the concatenated SDUs into individual SDUs, reorder the SDUs (e.g., according to SNs included in the concatenated SDUs), and discard any duplicate SDUs. The receiving wireless device may then perform header or uplink decompression on the SDUs to obtain the SDUs initially generated by the transmitting wireless device.

In some implementations, the positioning of the PDCP header within the PDCP-PDU relative to the concatenated SDUs 225 may cause challenges for integrity protection 230 and ciphering 240 for the concatenated SDUs 225, because ciphering 240 (and deciphering) may only apply to data portions of the PDCP PDU. That is, the PDCP headers (including SDAP headers) and SDAP control PDUs may not undergo ciphering (e.g., ciphering may not apply to the SDAP header or the SDAP control PDUs).

In some examples, SDAP headers and SDAP control PDUs may be placed within a PDCP PDU such that the SDAP headers do not undergo ciphering, and such that the location of the SDAP header reduces ciphering complexity at the transmitting wireless device and deciphering complexity at the receiving wireless device. In some examples, the SDAP headers may be placed at the beginning of the concatenated SDUs 225 as part of a concatenation header. In some examples, an SDAP control PDU is not concatenated with any SDUs, and instead skips the one or more concatenation buffers 220 and is forwarded directly to the radio link control for transmission by the transmitting wireless device. In some examples, the presence of an SDAP control PDU triggers a forwarding of the concatenated SDUs 225 already present in the one or more concatenation buffers 220 (e.g., the SDAP control PDU force empties the one or more concatenation buffers 220) for transmission, which preserves the ordering of the SDUs and the SDAP control PDU. In some examples, the SDAP control PDU is placed at the beginning of the concatenated SDU 225 as part of a concatenation header.

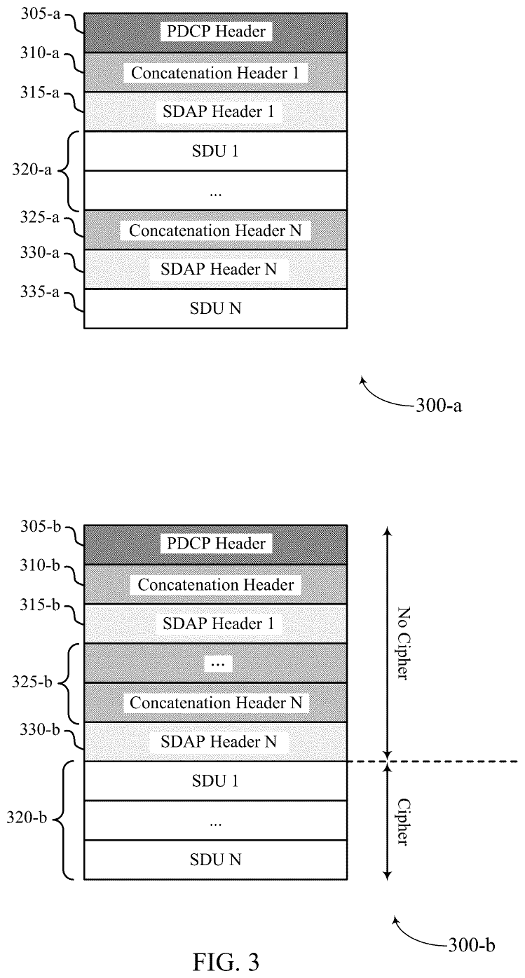

FIG. 3 shows examples of an SDAP header placement configuration 300-a and an SDAP header placement configuration 300-b that support techniques for handling SDAP headers with PDCP concatenation in accordance with one or more aspects of the present disclosure. The SDAP header placement configuration 300-a and the SDAP header placement configuration 300-b may implement, or be implemented by, one or more aspects of the wireless communications systems 100. For example, the SDAP header placement configuration 300-a and the SDAP header placement configuration 300-b may be implemented at or by a transmitting wireless device, a receiving wireless device, or both, which may be examples of a UE 115 or a network entity 105 described with reference to FIG. 1.

The SDAP header placement configuration 300-a may include a PDCP header 305-a, one or more concatenation headers (e.g., a first concatenation header 310-a, a concatenation header N 325-a), one or more SDAP headers (e.g., a first SDAP header 315-a, an SDAP header N 330-a), and a set of SDUs 320-a, and an SDU N 335-a. In some examples, the SDAP header placement configuration 300-a may allow for a transmitting wireless device to place an SDAP header (e.g., a first SDAP header 315-a) before each SDU in the set of SDUs 320-a, ending with the SDAP header N 330-a placed before the SDU N 335-a. In some cases, however, this SDAP header placement configuration 300-a may be relatively more hardware and processing intensive, because a transmitting wireless device may selectively apply ciphering for the SDAP headers that occur within the concatenated SDU, and a receiving wireless device may similarly apply deciphering for the SDAP headers.

To reduce processing complexity, a transmitting wireless device may implement SDAP header placement configuration 300-b, where the transmitting wireless device may place the SDAP headers at the beginning of the concatenated SDU as part of the concatenation header. For example, the concatenated SDU may include a PDCP header 305-b, one or more concatenation headers (e.g., a first concatenation header 310-b, a set of concatenation headers N 325-b), one or more SDAP headers (e.g., a first SDAP header 315-b, an SDAP header N 330-b), and a set of SDUs 320-b (including a first SDU to an SDU N). The transmitting wireless device may place or group the SDAP headers (e.g., the first SDAP header 315-b through the SDAP header N 330-b, each corresponding with respective SDUs in the set of SDUs 320-b) at the beginning of the concatenated SDU such that the SDAP headers occur with the PDCP header 305-b and the concatenation headers 325-b. In such examples, the concatenation headers may include an indication of the length of the set of SDUs 320-b plus the SDAP header if present. In cases that the SDAP headers are placed at the beginning of the concatenated SDU, the transmitting wireless device may refrain from ciphering the first portion of the concatenated SDU (including the PDCP headers, the concatenation headers and the SDAP headers), and may apply ciphering to the second portion of the concatenated SDU (including the set of SDUs 320-b).

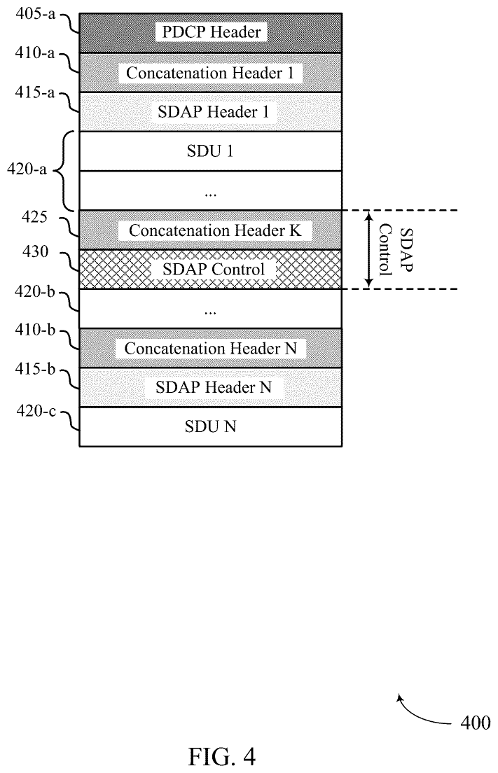

FIG. 4 shows an example of an SDAP control PDU placement configuration 400 that supports techniques for handling SDAP headers with PDCP concatenation in accordance with one or more aspects of the present disclosure. The SDAP control PDU placement configuration 400 may implement, or be implemented by, one or more aspects of the wireless communications systems 100. For example, the SDAP control PDU placement configuration 400 may be implemented at or by a transmitting wireless device, a receiving wireless device, or both, which may be examples of a UE 115 or a network entity 105 described with reference to FIG. 1.

The SDAP control PDU placement configuration 400 may include a PDCP header 405-a, one or more concatenation headers (e.g., a first concatenation header 410-a, a concatenation header K 425, a concatenation header N 410-b), one or more SDAP headers (e.g., a first SDAP header 415-a, an SDAP header N 415-b), and a set of SDUs 420-a, an SDU 420-b, and an SDU N 420-c. The SDAP header placement configuration may also include a SDAP control PDU 430 (e.g., an end marker), which may include control information with no data payload, and may follow in the PDCP as an eight-bit length data PDU. In some examples, the SDAP control PDU 430 may be located in a control region of the concatenated SDU, which may include the concatenation header K 425 and the SDAP control PDU 430.

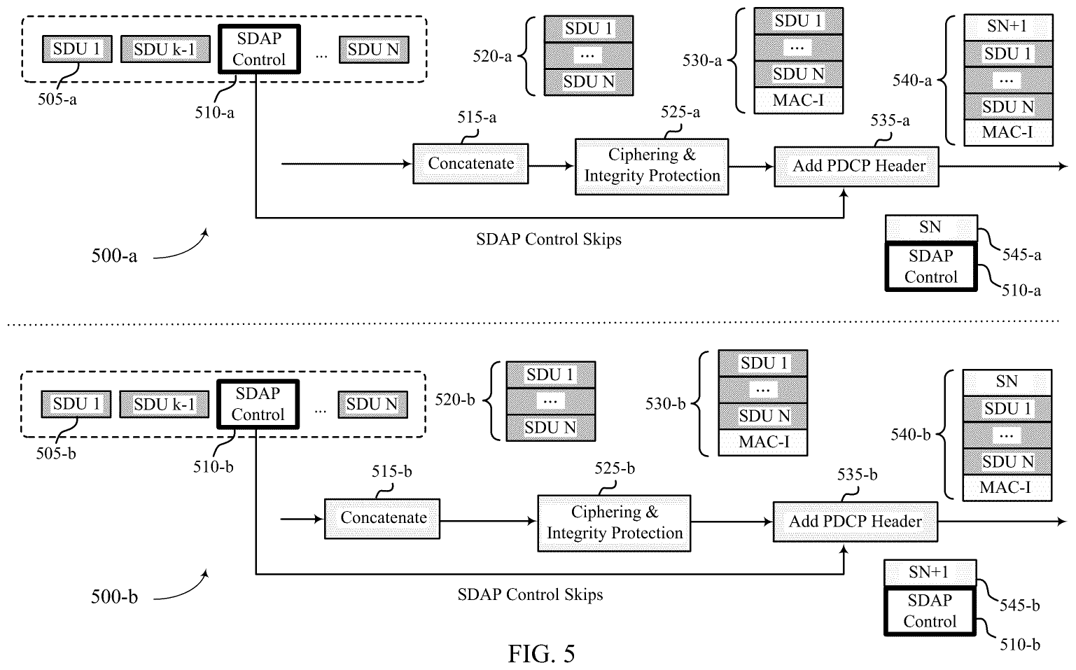

In some examples, the transmitting wireless device may send the SDAP control PDU 430 to a concatenation buffer similar to other data SDUs in the concatenated SDU (e.g., the SDAP control PDU 430 flows to the concatenation buffer with other data SDUs). In some cases, however, treating the SDAP control PDU 430 as a data SDU may introduce challenges for ciphering and deciphering the concatenated SDU because the SDAP control PDU may be placed in any arbitrary location within the concatenated SDU, and the SDAP control PDU may be excluded from ciphering. The transmitting wireless device, therefore, may implement one or more techniques for handling the SDAP control PDU, as described with reference to FIG. 5. For instance, the SDAP control PDU may be processed separate from other SDUs during concatenation (e.g., for forming a concatenated SDU), where the SDAP control PDU may be recombined with other SDUs (e.g., after concatenation) when a PDCP header is added. In some examples, the presence of the SDAP control PDU may trigger forwarding of a current concatenated SDU (e.g., including two or more SDUs) even if a threshold concatenation size has not yet been satisfied, or if a concatenation timer has not yet expired, or both. In such cases, the SDAP control SDU may skip concatenation and be combined with other SDUs when the PDCP header is added.

FIG. 5 shows example SDAP control PDU placement configurations 500-a and 500-b that support techniques for handling SDAP headers with PDCP concatenation in accordance with one or more aspects of the present disclosure. The SDAP control PDU placement configuration 500-a and the SDAP control PDU placement configuration 500-b may implement, or be implemented by, one or more aspects of the wireless communications systems 100. For example, the SDAP control PDU placement configuration 500-a and the SDAP control PDU placement configuration 500-b may be implemented at or by a transmitting wireless device, a receiving wireless device, or both, which may be examples of a UE 115 or a network entity 105 described with reference to FIG. 1.

The SDAP control PDU placement configuration 500-a may include a set of SDUs 505-a, including SDU 1, SDU k−1, to SDU N, which may be included as a concatenated SDU input into a transmission buffer of a transmitting wireless device. The transmitting wireless device may also identify an SDAP control PDU 510-a with the set of SDUs 505-a. In some examples, the transmitting wireless device may refrain from concatenating the SDAP control PDU, such that the PDCP entity skips the concatenation buffer step 515-a for the SDAP control PDU 510-a. The transmitting wireless device may output the SDAP control PDU 510-a to a radio link control (RLC) layer of the protocol stack for transmission, with any number of sequenced SDUs 545-a (e.g., in accordance with a sequence number (SN)). The transmitting wireless device may build (e.g., generate, construct, determine) the PDCP PDU by concatenating the SDUs 520-a during the concatenation buffer step 515-a, performing ciphering and integrity protection 525-a and addition the MAC-I for the concatenated SDUs at 530-a. The transmitting wireless device may then perform addition of the PDCP header 535-a to construct the PDCP PDU at 540-a. In some examples, refraining from concatenating the SDAP control PDU 510-a may reduce concatenation latency for the SDAP control PDU 510-a. In such examples, the receiving wireless device may receive the SDAP control PDU 510-a, and may receive the SDU 1 through SDU N, which may be concatenated and may arrive after the SDAP control PDU 510-a.

The SDAP control PDU placement configuration 500-b may include a set of SDUs 505-b, including SDU 1, SDU k−1, to SDU N, which may be included as a concatenated SDU fed to a transmission buffer of a transmitting wireless device. The transmitting wireless device may also identify an SDAP control PDU 510-b with the set of SDUs 505-b. In some examples, the PDCP entity at the transmitting wireless device may forward the current concatenated SDU 520-b even if the threshold (e.g., maximum) SDU size (e.g., maxSDUsize) is not reached, the concatenation timer has not yet expired (e.g., concatenationTimer is not yet expired), or both. In such cases, the transmitting wireless device may build the PDCP PDU by concatenating the SDUs 520-b during the concatenation buffer step 515-b, performing ciphering and integrity protection 525-b and addition the MAC-I for the concatenated SDUs at 530-b. The transmitting wireless device may then perform addition of the PDCP header 535-b to construct the PDCP PDU at 540-b. In some examples, the SDAP control PDU 510-b may be received at the RLC layer as SDU k within a 1, 2, . . . , k, . . . N SDU ordering (SN+1 ordering 545-b) within the concatenation window. In some examples, the identification of the SDAP control PDU 510-b may trigger forwarding of the current concatenated SDU, which may maintain the concatenated SDU ordering from the input at the transmitting wireless device. Such forced emptying of the concatenation buffer may allow the receiving wireless device to identify the last SDU before application of the SDAP control PDU 510-b, which may eliminate any ambiguity as to the ordering of the concatenated SDUs and the SDAP control PDU 510-a.

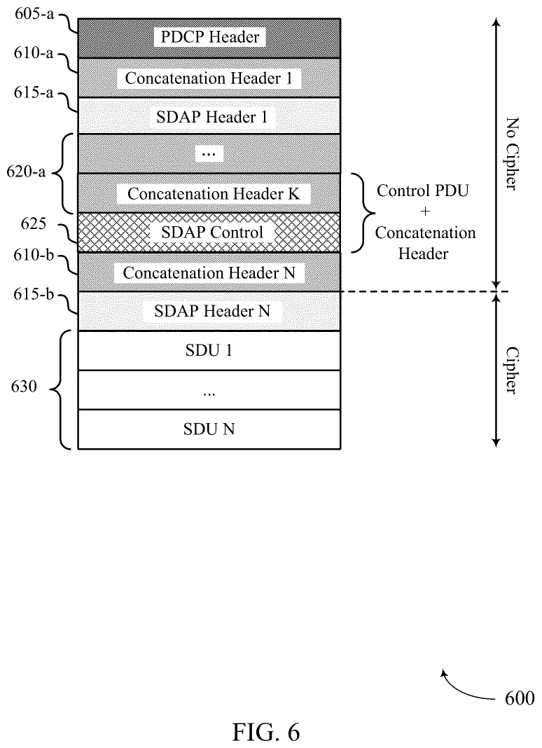

FIG. 6 shows an example of an SDAP control PDU placement configuration 600 that supports techniques for handling SDAP headers with PDCP concatenation in accordance with one or more aspects of the present disclosure. The SDAP control PDU placement configuration 600 may implement, or be implemented by, one or more aspects of the wireless communications systems 100. For example, the SDAP control PDU placement configuration 600 may be implemented at or by a transmitting wireless device, a receiving wireless device, or both, which may be examples of a UE 115 or a network entity 105 described with reference to FIG. 1.

The SDAP control PDU placement configuration 600 may include a PDCP header 605-a, one or more concatenation headers (e.g., a first concatenation header 610-a, a concatenation header N 610-b, a set of concatenation headers 620-a associated with the SDAP control PDU 625), one or more SDAP headers (e.g., a first SDAP header 615-a, an SDAP header N 615-b), an SDAP control PDU 625, and a set of SDUs 630. In some examples, the SDAP control PDU placement configuration 600 may allow for a transmitting wireless device to place the SDAP control PDU 625 at the beginning of the concatenated SDU as part of the concatenation header. In such examples, the concatenation header includes an indication of the length of the concatenated SDU (e.g., a length field), an SDAP header length, an SDAP control PDU length, or any combination thereof. In some examples, the length field may indicate a zero (e.g., “0”) value to inform the receiving wireless device that there is no data payload associated with the SDAP control PDU 625. Placement of the SDAP control PDU 625 at the beginning of the concatenated SDU as part of the concatenation header may reduce ambiguity associated with a placement of the SDAP control PDU 625 within the PDCP SDUs. For example, the SDAP control PDU placement configuration 600 shows the SDAP control PDU 625 at SDU k at the 1, . . . , N placement, although other example placements of the SDAP control PDU 625 are possible.

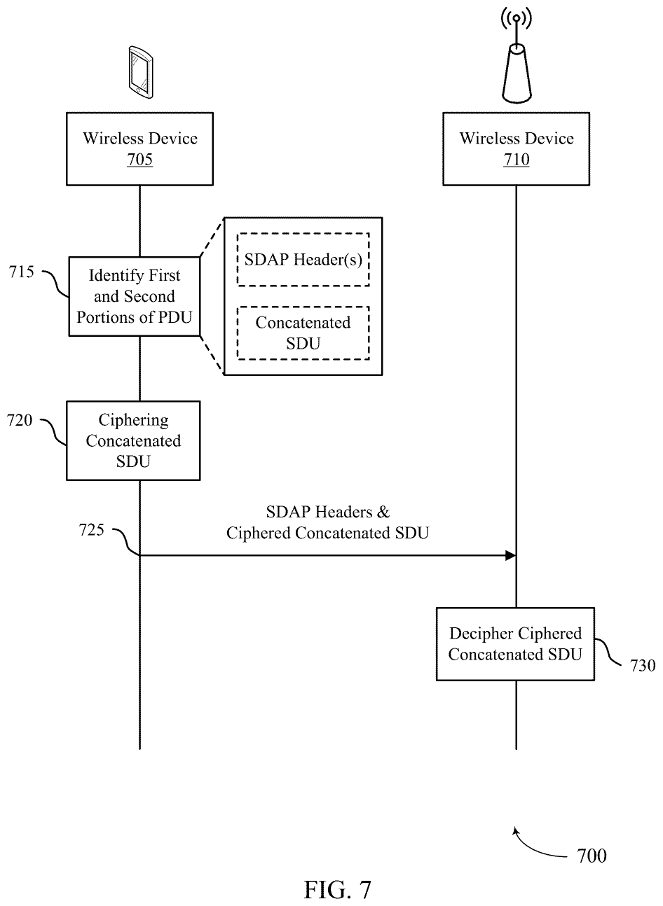

FIG. 7 shows an example of a process flow 700 that supports techniques for handling SDAP headers with PDCP concatenation in accordance with one or more aspects of the present disclosure. The process flow 700 may implement or be implemented by one or more aspects of the wireless communications system 100. For example, the process flow 700 may include (e.g., be implemented by) one or more wireless devices including UEs 115 and network entities 105 as described herein.

In the following description of process flow 700, the operations may be performed in a different order than the order shown, or other operations may be added or removed from the process flow 700. For example, some operations may also be left out of process flow 700, may be performed in different orders or at different times, or other operations may be added to process flow 700. Although communications of the process flow 700 are shown occurring between a first wireless device and a second wireless device, the operations of process flow 700 may also be performed by one or more other wireless devices, network devices, or network functions.

At 715, the first wireless device 705 may identify a first portion and a second portion of a PDU. In some cases, the first portion may include one or more SDAP headers and the second portion may include a concatenated SDU that includes a quantity of concatenated SDUs. In some examples, the PDU may be a PDCP PDU, a PDCP control PDU, one or more ROHC PDUs, or one or more ethernet header compression (EHC) PDUs, or any combination thereof.

At 720, the first wireless device 705 may cipher the concatenated SDU based on the concatenated SDU being separate from the one or more SDAP headers. In some examples, the one or more SDAP headers are included as part of one or more respective concatenation headers of the PDU. In some such examples, the one or more SDAP headers and the one or more respective concatenation headers are unciphered based on the concatenated SDU being separate from one or more SDAP headers and the one or more respective concatenation headers. In some other examples, a first SDAP header is adjacent to a first SDU included in the quantity of SDUs, and a second SDAP header is adjacent to a second SDU included in the quantity of SDUs. In some such examples, the one or more SDAP headers are ciphered or unciphered based on the ciphering of the concatenated SDU.

In some examples, the one or more SDAP headers include an SDAP control PDU, and the first wireless device 705 may output the quantity of SDUs with the SDAP control PDU to a concatenation buffer. In some other examples where the one or more SDAP headers include an SDAP control PDU, the first wireless device 705 may output the SDAP control PDU for transmission to the second wireless device 710 such that the SDAP control PDU is excluded from concatenation with the quantity of SDUs. In such examples, the first wireless device 705 may refrain from adding the SDAP control PDU to the concatenation buffer, and may apply the SDAP control PDU for transmission to the second wireless device 710 after addition of a PDCP header.

In some examples in which the one or more SDAP headers include an SDAP control PDU, the first wireless device 705 may output the concatenated SDU from a concatenation buffer based on detecting the SDAP control PDU among the quantity of SDUs. The first wireless device 705 may then output the SDAP control PDU with the quantity of SDUs for transmission to the second wireless device 710. In some such examples, the first wireless device 705 may output the concatenated SDU from the concatenation buffer irrespective of whether a quantity of the SDUs satisfies a threshold quantity, whether a concatenation timer is expired, or both (e.g., in response to detecting the SDAP control PDU).

In some examples in which the one or more SDAP headers include an SDAP control PDU, the first wireless device 705 may output the PDU for transmission to the second wireless device 710, where the SDAP control PDU is included as part of a respective concatenation header of the PDU, and where the SDAP control PDU and the respective concatenation header occur prior to the concatenated SDU. In such examples, the respective concatenation header includes at least a length field that indicates a payload size of the SDAP control PDU, where a payload size of zero indicates a presence of the SDAP control PDU.

At 725, the first wireless device may transmit one or more messages to the second wireless device 710 which include the one or more SDAP headers and the ciphered concatenated SDU. In some examples, the one or more unciphered SDAP headers each include an unciphered SDAP control PDU which is separate from the ciphered concatenated SDU. In some such examples, the unciphered SDAP control PDU is included as part of a respective concatenation header of the PDU, where the unciphered SDAP control PDU and the respective concatenation header occur prior to the quantity of ciphered concatenated SDUs.

At 730, the second wireless device may receive the PDU that includes the first portion (e.g., one or more unciphered SDAP headers) and the second portion (e.g., the quantity of SDUs).

At 735, the second wireless device may decipher the second portion of the PDU (e.g., the quantity of SDUs, the data portion of the PDU) based on the ciphered concatenated SDU being separate from the one or more unciphered SDAP headers. In some examples, the one or more SDAP headers are included as part of one or more respective concatenation headers of the PDU, where the one or more SDAP headers and the one or more respective concatenation headers are unciphered based on the concatenated SDU being separate from the one or more SDAP headers and the one or more respective concatenation headers.

In some examples, a first SDAP header of the one or more SDAP headers is adjacent to a first SDU of the quantity of concatenated SDUs and a second SDAP header of the one or more SDAP headers is adjacent to a second SDU of the quantity of concatenated SDUs.

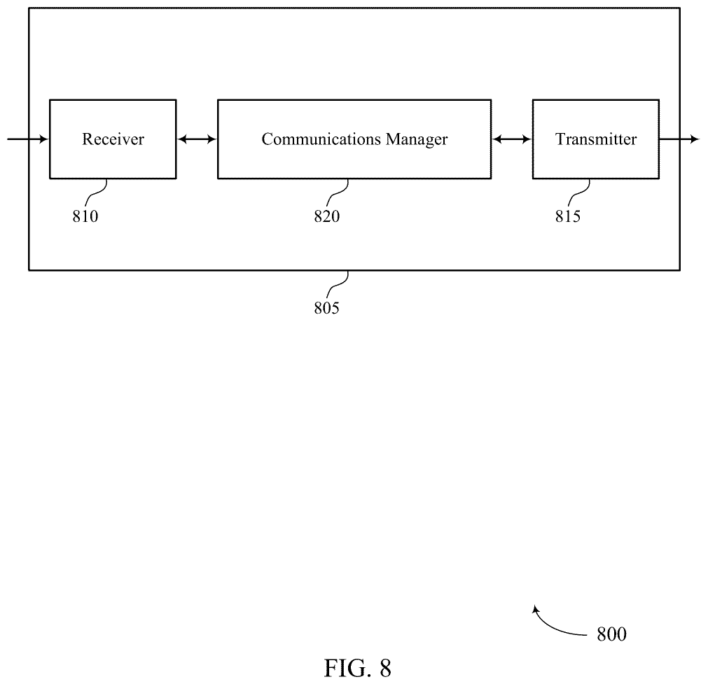

FIG. 8 shows a block diagram 800 of a device 805 that supports techniques for handling SDAP headers with PDCP concatenation in accordance with one or more aspects of the present disclosure. The device 805 may be an example of aspects of a UE 115 or a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for handling SDAP headers with PDCP concatenation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for handling SDAP headers with PDCP concatenation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for handling SDAP headers with PDCP concatenation as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for identifying a first portion and a second portion of a PDU, the first portion including one or more SDAP headers and the second portion including a concatenated SDU that includes a set of multiple SDUs. The communications manager 820 is capable of, configured to, or operable to support a means for ciphering the concatenated SDU based on the concatenated SDU being separate from the one or more SDAP headers. The communications manager 820 is capable of, configured to, or operable to support a means for transmitting, to a second wireless device, one or more messages including the PDU including the one or more SDAP headers and the ciphered concatenated SDU.

Additionally, or alternatively, the communications manager 820 may support wireless communications in accordance with examples as disclosed herein. For example, the communications manager 820 is capable of, configured to, or operable to support a means for receiving a PDU including a first portion and a second portion, the first portion including one or more unciphered SDAP headers and the second portion including a ciphered concatenated SDU that includes a set of multiple SDUs. The communications manager 820 is capable of, configured to, or operable to support a means for deciphering the second portion of the PDU based on the ciphered concatenated SDU being separate from the one or more unciphered SDAP headers.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, reduced cryptographic processing time, higher throughput, reduced hardware burden (e.g., reduced hardware engine utilization, reduced number of hardware invocations), and increased efficiency for ciphering and deciphering PDCP PDUs.

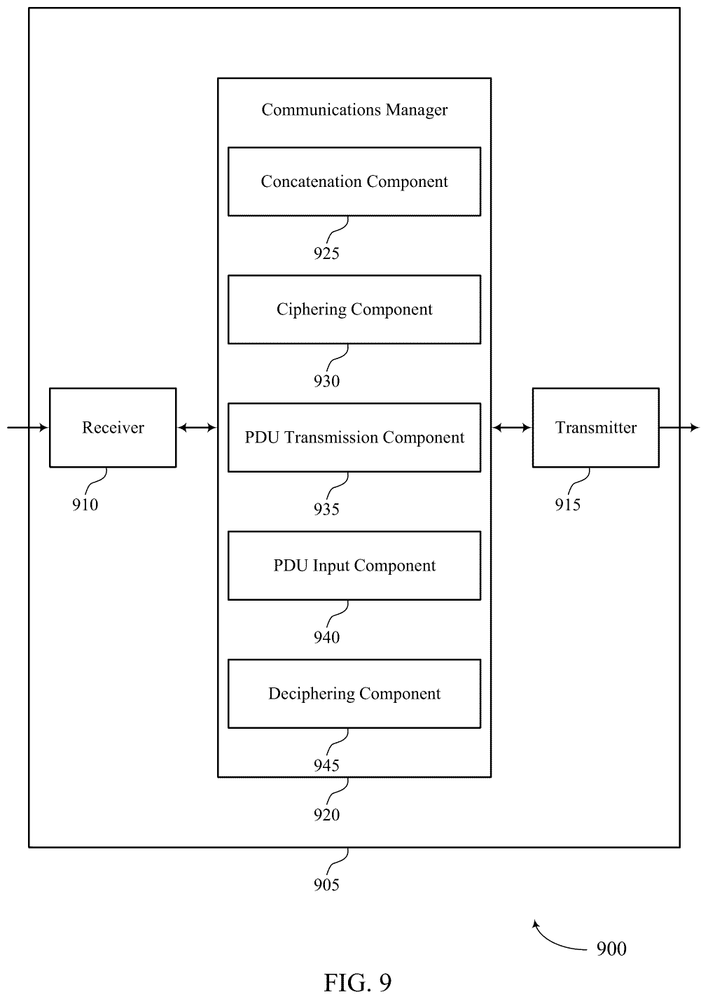

FIG. 9 shows a block diagram 900 of a device 905 that supports techniques for handling SDAP headers with PDCP concatenation in accordance with one or more aspects of the present disclosure. The device 905 may be an example of aspects of a device 805, a UE 115, or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for handling SDAP headers with PDCP concatenation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for handling SDAP headers with PDCP concatenation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for handling SDAP headers with PDCP concatenation as described herein. For example, the communications manager 920 may include a concatenation component 925, a ciphering component 930, a PDU transmission component 935, a PDU input component 940, a deciphering component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The concatenation component 925 is capable of, configured to, or operable to support a means for identifying a first portion and a second portion of a PDU, the first portion including one or more SDAP headers and the second portion including a concatenated SDU that includes a set of multiple SDUs. The ciphering component 930 is capable of, configured to, or operable to support a means for ciphering the concatenated SDU based on the concatenated SDU being separate from the one or more SDAP headers. The PDU transmission component 935 is capable of, configured to, or operable to support a means for transmitting, to a second wireless device, one or more messages including the PDU including the one or more SDAP headers and the ciphered concatenated SDU.

Additionally, or alternatively, the communications manager 920 may support wireless communications in accordance with examples as disclosed herein. The PDU input component 940 is capable of, configured to, or operable to support a means for receiving a PDU including a first portion and a second portion, the first portion including one or more unciphered SDAP headers and the second portion including a ciphered concatenated SDU that includes a set of multiple SDUs. The deciphering component 945 is capable of, configured to, or operable to support a means for deciphering the second portion of the PDU based on the ciphered concatenated SDU being separate from the one or more unciphered SDAP headers.

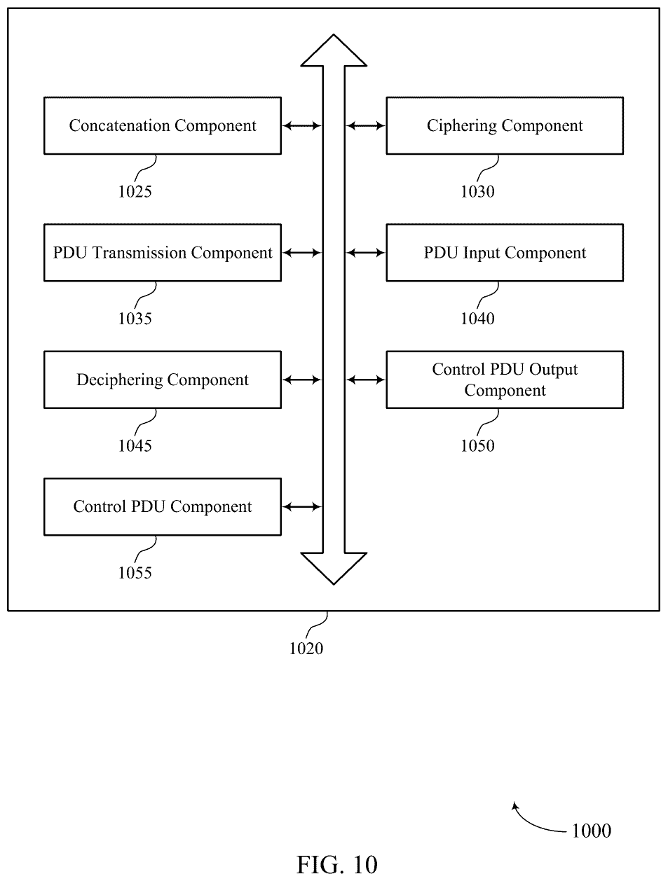

FIG. 10 shows a block diagram 1000 of a communications manager 1020 that supports techniques for handling SDAP headers with PDCP concatenation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for handling SDAP headers with PDCP concatenation as described herein. For example, the communications manager 1020 may include a concatenation component 1025, a ciphering component 1030, a PDU transmission component 1035, a PDU input component 1040, a deciphering component 1045, a control PDU output component 1050, a control PDU component 1055, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The concatenation component 1025 is capable of, configured to, or operable to support a means for identifying a first portion and a second portion of a PDU, the first portion including one or more SDAP headers and the second portion including a concatenated SDU that includes a set of multiple SDUs. The ciphering component 1030 is capable of, configured to, or operable to support a means for ciphering the concatenated SDU based on the concatenated SDU being separate from the one or more SDAP headers. The PDU transmission component 1035 is capable of, configured to, or operable to support a means for transmitting, to a second wireless device, one or more messages including the PDU including the one or more SDAP headers and the ciphered concatenated SDU.

In some examples, the one or more SDAP headers are included as part of one or more respective concatenation headers of the PDU. In some examples, the one or more SDAP headers and the one or more respective concatenation headers are unciphered based on the concatenated SDU being separate from the one or more SDAP headers and the one or more respective concatenation headers.

In some examples, a first SDAP header of the one or more SDAP headers is adjacent to a first SDU of the set of multiple SDUs and a second SDAP header of the one or more SDAP headers is adjacent to a second SDU of the set of multiple SDUs. In some examples, the one or more SDAP headers are cyphered or uncyphered based on the ciphering of the concatenated SDU.

In some examples, the one or more SDAP headers include a SDAP control PDU, and the concatenation component 1025 is capable of, configured to, or operable to support a means for outputting, to a concatenation buffer, the set of multiple SDUs with the SDAP control PDU.

In some examples, the one or more SDAP headers include a SDAP control PDU, and the control PDU output component 1050 is capable of, configured to, or operable to support a means for outputting the SDAP control PDU for transmission to the second wireless device, where the SDAP control PDU is excluded from concatenation with the set of multiple SDUs.

In some examples, the control PDU output component 1050 is capable of, configured to, or operable to support a means for skipping addition of the SDAP control PDU to concatenation buffer for obtaining the concatenated SDU. In some examples, the control PDU output component 1050 is capable of, configured to, or operable to support a means for applying the SDAP control PDU for transmission to the second wireless device after addition of a PDCP header.

In some examples, the one or more SDAP headers include a SDAP control PDU, and the concatenation component 1025 is capable of, configured to, or operable to support a means for outputting the concatenated SDU from a concatenation buffer based on detecting the SDAP control PDU among the set of multiple SDUs. In some examples, the one or more SDAP headers include a SDAP control PDU, and the control PDU output component 1050 is capable of, configured to, or operable to support a means for outputting, for transmission to the second wireless device, the SDAP control PDU with the set of multiple SDUs of the concatenated SDU.

In some examples, to support outputting the concatenated SDU from the concatenation buffer, the control PDU output component 1050 is capable of, configured to, or operable to support a means for outputting the concatenated SDU from the concatenation buffer irrespective of whether a quantity of the set of multiple SDUs satisfies a threshold quantity, whether a concatenation timer is expired, or both, in response to detecting the SDAP control PDU.

In some examples, the one or more SDAP headers include a SDAP control PDU, and the control PDU output component 1050 is capable of, configured to, or operable to support a means for outputting the PDU for transmission to the second wireless device, where the SDAP control PDU is included as part of a respective concatenation header of the PDU, and where the SDAP control PDU and the respective concatenation header occur prior to the concatenated SDU.

In some examples, the respective concatenation header includes a length field that indicates a payload size of the SDAP control PDU. In some examples, the payload size including a value of zero indicates a presence of the SDAP control PDU. In some examples, the PDU includes a PDCP PDU, a PDCP control PDU, one or more ROHC PDUs, one or more EHC PDUs, or any combination thereof.

Additionally, or alternatively, the communications manager 1020 may support wireless communications in accordance with examples as disclosed herein. The PDU input component 1040 is capable of, configured to, or operable to support a means for receiving a PDU including a first portion and a second portion, the first portion including one or more unciphered SDAP headers and the second portion including a ciphered concatenated SDU that includes a set of multiple SDUs. The deciphering component 1045 is capable of, configured to, or operable to support a means for deciphering the second portion of the PDU based on the ciphered concatenated SDU being separate from the one or more unciphered SDAP headers.

In some examples, the one or more SDAP headers are included as part of one or more respective concatenation headers of the PDU. In some examples, the one or more SDAP headers and the one or more respective concatenation headers are unciphered based on the concatenated SDU being separate from the one or more SDAP headers and the one or more respective concatenation headers.

In some examples, a first SDAP header of the one or more SDAP headers is adjacent to a first SDU of the set of multiple concatenated SDUs and a second SDAP header of the one or more SDAP headers is adjacent to a second SDU of the set of multiple concatenated SDUs. In some examples, the one or more unciphered SDAP headers each include an unciphered SDAP control PDU. In some examples, the unciphered SDAP control PDU is separate from the ciphered concatenated SDU.

In some examples, the unciphered SDAP control PDU is included as part of a respective concatenation header of the PDU. In some examples, the unciphered SDAP control PDU and the respective concatenation header occur prior to the set of multiple ciphered concatenated SDUs. In some examples, the respective concatenation header includes a length field that indicates a payload size of the unciphered SDAP control PDU.

In some examples, the control PDU component 1055 is capable of, configured to, or operable to support a means for identifying a first unciphered SDAP control PDU based on a payload size of a first length field including a value of zero. In some examples, the PDU includes a PDCP PDU, a PDCP control PDU, one or more ROHC PDUs, one or more EHC PDUs, other PDUs, or any combination thereof.

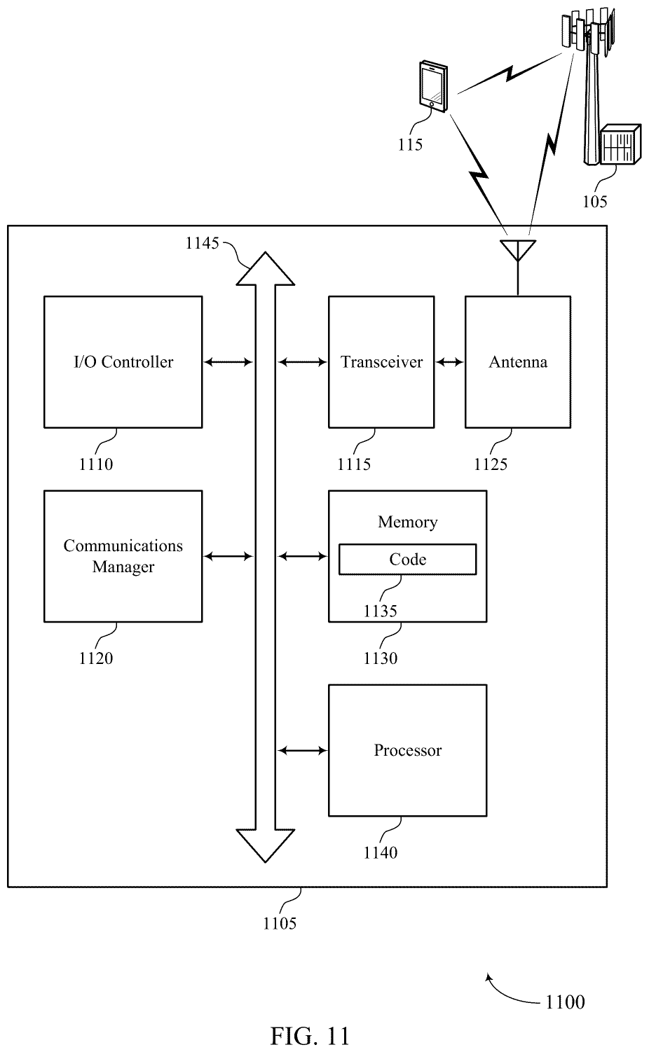

FIG. 11 shows a diagram of a system 1100 including a device 1105 that supports techniques for handling SDAP headers with PDCP concatenation in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable code 1135 including instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may contain, among other things, a basic I/O system (BIOS) which may control basic hardware or software operation such as the interaction with peripheral components or devices.

The at least one processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting techniques for handling SDAP headers with PDCP concatenation). For example, the device 1105 or a component of the device 1105 may include at least one processor 1140 and at least one memory 1130 coupled with or to the at least one processor 1140, the at least one processor 1140 and at least one memory 1130 configured to perform various functions described herein. In some examples, the at least one processor 1140 may include multiple processors and the at least one memory 1130 may include multiple memories. One or more of the multiple processors may be coupled with one or more of the multiple memories, which may, individually or collectively, be configured to perform various functions herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for identifying a first portion and a second portion of a PDU, the first portion including one or more SDAP headers and the second portion including a concatenated SDU that includes a set of multiple SDUs. The communications manager 1120 is capable of, configured to, or operable to support a means for ciphering the concatenated SDU based on the concatenated SDU being separate from the one or more SDAP headers. The communications manager 1120 is capable of, configured to, or operable to support a means for transmitting, to a second wireless device, one or more messages including the PDU including the one or more SDAP headers and the ciphered concatenated SDU.

Additionally, or alternatively, the communications manager 1120 may support wireless communications in accordance with examples as disclosed herein. For example, the communications manager 1120 is capable of, configured to, or operable to support a means for receiving a PDU including a first portion and a second portion, the first portion including one or more unciphered SDAP headers and the second portion including a ciphered concatenated SDU that includes a set of multiple SDUs. The communications manager 1120 is capable of, configured to, or operable to support a means for deciphering the second portion of the PDU based on the ciphered concatenated SDU being separate from the one or more unciphered SDAP headers.

By including or configuring the communications manager 1120 in accordance with examples as described herein, the device 1105 may support techniques for improved communication reliability, reduced latency, improved user experience related to reduced processing, reduced power consumption, improved coordination between devices, longer battery life, improved utilization of processing capability, reduced cryptographic processing time, higher throughput, lower communications overhead, reduced hardware burden (e.g., reduced hardware engine utilization, reduced number of hardware invocations), and increased efficiency for ciphering and deciphering PDCP PDUs.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of techniques for handling SDAP headers with PDCP concatenation as described herein, or the at least one processor 1140 and the at least one memory 1130 may be otherwise configured to, individually or collectively, perform or support such operations.

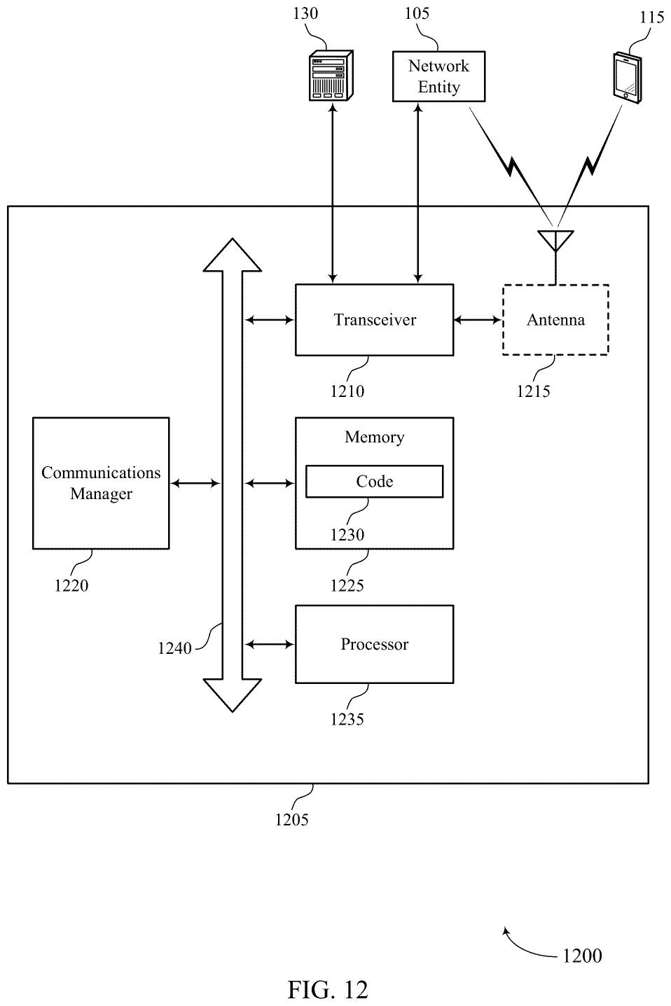

FIG. 12 shows a diagram of a system 1200 including a device 1205 that supports techniques for handling SDAP headers with PDCP concatenation in accordance with one or more aspects of the present disclosure. The device 1205 may be an example of or include the components of a device 805, a device 905, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for handling SDAP headers with PDCP concatenation). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for identifying a first portion and a second portion of a PDU, the first portion including one or more SDAP headers and the second portion including a concatenated SDU that includes a set of multiple SDUs. The communications manager 1220 is capable of, configured to, or operable to support a means for ciphering the concatenated SDU based on the concatenated SDU being separate from the one or more SDAP headers. The communications manager 1220 is capable of, configured to, or operable to support a means for transmitting, to a second wireless device, one or more messages including the PDU including the one or more SDAP headers and the ciphered concatenated SDU.

Additionally, or alternatively, the communications manager 1220 may support wireless communications in accordance with examples as disclosed herein. For example, the communications manager 1220 is capable of, configured to, or operable to support a means for receiving a PDU including a first portion and a second portion, the first portion including one or more unciphered SDAP headers and the second portion including a ciphered concatenated SDU that includes a set of multiple SDUs. The communications manager 1220 is capable of, configured to, or operable to support a means for deciphering the second portion of the PDU based on the ciphered concatenated SDU being separate from the one or more unciphered SDAP headers.

By including or configuring the communications manager 1220 in accordance with examples as described herein, the device 1205 may support techniques for reduced processing, reduced power consumption, reduced cryptographic processing time, higher throughput, reduced hardware burden (e.g., reduced hardware engine utilization, reduced number of hardware invocations), and increased efficiency for ciphering and deciphering PDCP PDUs.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for handling SDAP headers with PDCP concatenation as described herein, or the at least one processor 1235 and the at least one memory 1225 may be otherwise configured to, individually or collectively, perform or support such operations.

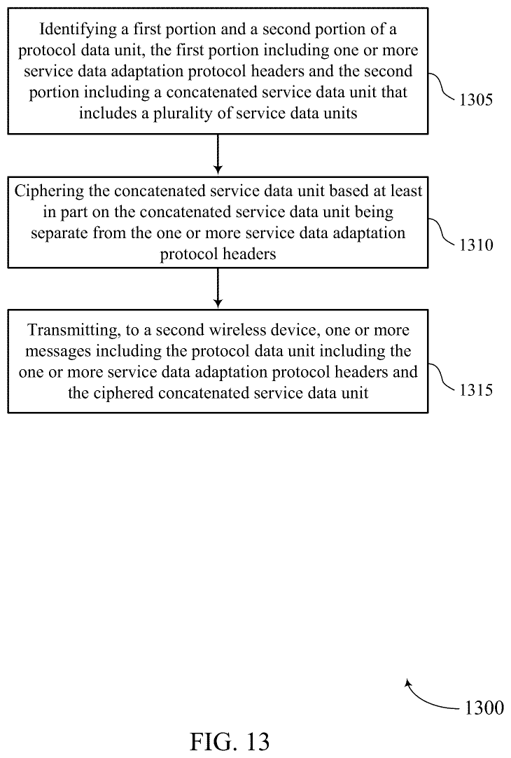

FIG. 13 shows a flowchart illustrating a method 1300 that supports techniques for handling SDAP headers with PDCP concatenation in accordance with one or more aspects of the present disclosure. The operations of the method 1300 may be implemented by a wireless device (e.g., a UE, a network entity) or its components as described herein. For example, the operations of the method 1300 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include identifying a first portion and a second portion of a PDU, the first portion including one or more SDAP headers and the second portion including a concatenated SDU that includes a set of multiple SDUs. The operations of 1305 may be performed in accordance with examples as disclosed herein. In some examples, aspects of the operations of 1305 may be performed by a concatenation component 1025 as described with reference to FIG. 10.

At 1310, the method may include ciphering the concatenated SDU based on the concatenated SDU being separate from the one or more SDAP headers. The operations of 1310 may be performed in accordance with examples as disclosed herein. In some examples, aspects of the operations of 1310 may be performed by a ciphering component 1030 as described with reference to FIG. 10.

At 1315, the method may include transmitting, to a second wireless device, one or more messages including the PDU including the one or more SDAP headers and the ciphered concatenated SDU. The operations of 1315 may be performed in accordance with examples as disclosed herein. In some examples, aspects of the operations of 1315 may be performed by a PDU transmission component 1035 as described with reference to FIG. 10.

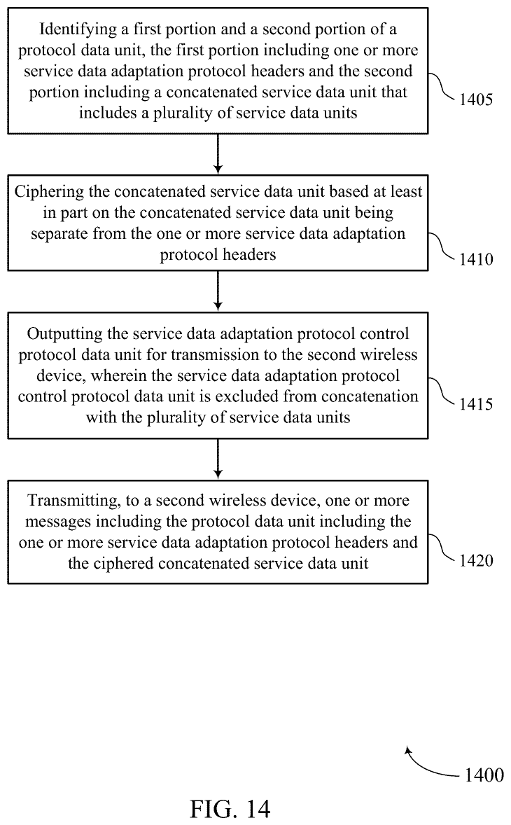

FIG. 14 shows a flowchart illustrating a method 1400 that supports techniques for handling SDAP headers with PDCP concatenation in accordance with one or more aspects of the present disclosure. The operations of the method 1400 may be implemented by a wireless device (e.g., a UE, a network entity) or its components as described herein. For example, the operations of the method 1400 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include identifying a first portion and a second portion of a PDU, the first portion including one or more SDAP headers and the second portion including a concatenated SDU that includes a set of multiple SDUs. The operations of 1405 may be performed in accordance with examples as disclosed herein. In some examples, aspects of the operations of 1405 may be performed by a concatenation component 1025 as described with reference to FIG. 10.

At 1410, the method may include ciphering the concatenated SDU based on the concatenated SDU being separate from the one or more SDAP headers. The operations of 1410 may be performed in accordance with examples as disclosed herein. In some examples, aspects of the operations of 1410 may be performed by a ciphering component 1030 as described with reference to FIG. 10.

At 1415, the method may include outputting the SDAP control PDU for transmission to the second wireless device, where the SDAP control PDU is excluded from concatenation with the set of multiple SDUs. The operations of 1415 may be performed in accordance with examples as disclosed herein. In some examples, aspects of the operations of 1415 may be performed by a control PDU output component 1050 as described with reference to FIG. 10.

At 1420, the method may include transmitting, to a second wireless device, one or more messages including the PDU including the one or more SDAP headers and the ciphered concatenated SDU. The operations of 1420 may be performed in accordance with examples as disclosed herein. In some examples, aspects of the operations of 1420 may be performed by a PDU transmission component 1035 as described with reference to FIG. 10.

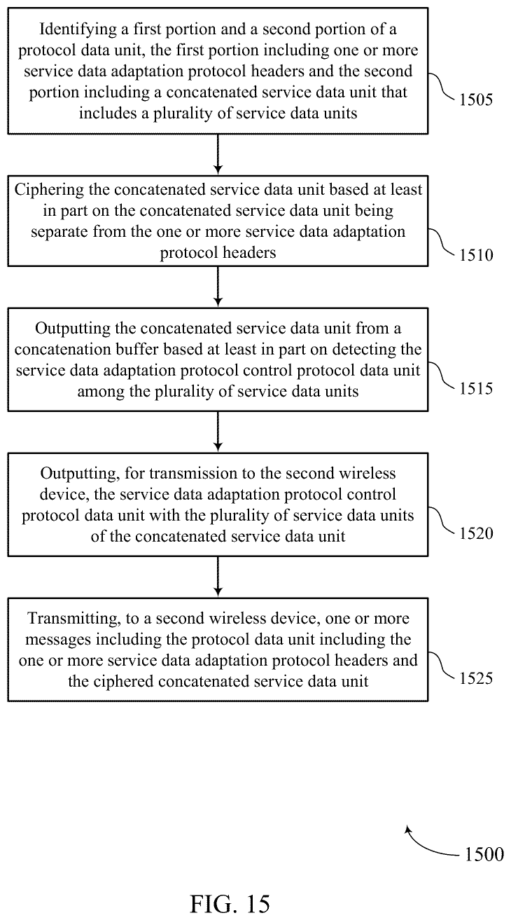

FIG. 15 shows a flowchart illustrating a method 1500 that supports techniques for handling SDAP headers with PDCP concatenation in accordance with one or more aspects of the present disclosure. The operations of the method 1500 may be implemented by a wireless device (e.g., a UE, a network entity) or its components as described herein. For example, the operations of the method 1500 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include identifying a first portion and a second portion of a PDU, the first portion including one or more SDAP headers and the second portion including a concatenated SDU that includes a set of multiple SDUs. The operations of 1505 may be performed in accordance with examples as disclosed herein. In some examples, aspects of the operations of 1505 may be performed by a concatenation component 1025 as described with reference to FIG. 10.

At 1510, the method may include ciphering the concatenated SDU based on the concatenated SDU being separate from the one or more SDAP headers. The operations of 1510 may be performed in accordance with examples as disclosed herein. In some examples, aspects of the operations of 1510 may be performed by a ciphering component 1030 as described with reference to FIG. 10.

At 1515, the method may include outputting the concatenated SDU from a concatenation buffer based on detecting the SDAP control PDU among the set of multiple SDUs. The operations of 1515 may be performed in accordance with examples as disclosed herein. In some examples, aspects of the operations of 1515 may be performed by a concatenation component 1025 as described with reference to FIG. 10.

At 1520, the method may include outputting, for transmission to the second wireless device, the SDAP control PDU with the set of multiple SDUs of the concatenated SDU. The operations of 1520 may be performed in accordance with examples as disclosed herein. In some examples, aspects of the operations of 1520 may be performed by a control PDU output component 1050 as described with reference to FIG. 10.

At 1525, the method may include transmitting, to a second wireless device, one or more messages including the PDU including the one or more SDAP headers and the ciphered concatenated SDU. The operations of 1525 may be performed in accordance with examples as disclosed herein. In some examples, aspects of the operations of 1525 may be performed by a PDU transmission component 1035 as described with reference to FIG. 10.

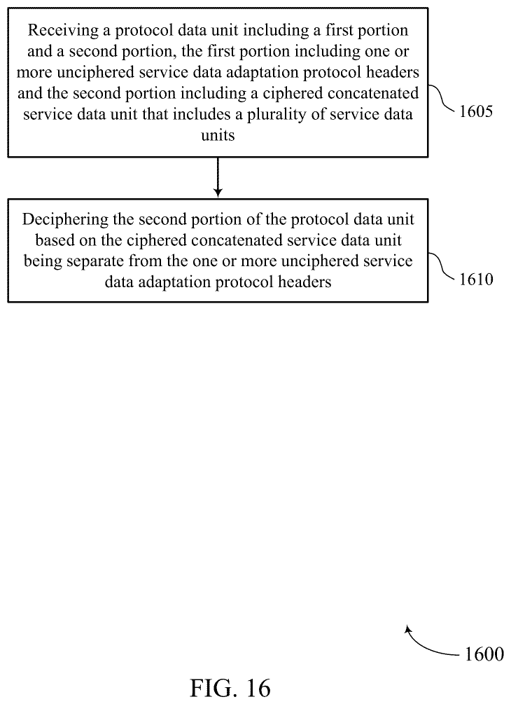

FIG. 16 shows a flowchart illustrating a method 1600 that supports techniques for handling SDAP headers with PDCP concatenation in accordance with one or more aspects of the present disclosure. The operations of the method 1600 may be implemented by a wireless device (e.g., a UE, a network entity) or its components as described herein. For example, the operations of the method 1600 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include receiving a PDU including a first portion and a second portion, the first portion including one or more unciphered SDAP headers and the second portion including a ciphered concatenated SDU that includes a set of multiple SDUs. The operations of 1605 may be performed in accordance with examples as disclosed herein. In some examples, aspects of the operations of 1605 may be performed by a PDU input component 1040 as described with reference to FIG. 10.

At 1610, the method may include deciphering the second portion of the PDU based on the ciphered concatenated SDU being separate from the one or more unciphered SDAP headers. The operations of 1610 may be performed in accordance with examples as disclosed herein. In some examples, aspects of the operations of 1610 may be performed by a deciphering component 1045 as described with reference to FIG. 10.

The following provides an overview of aspects of the present disclosure:

Aspect 1: A method for wireless communications, comprising: identifying a first portion and a second portion of a PDU, the first portion comprising one or more SDAP headers and the second portion comprising a concatenated SDU that includes a plurality of SDUs; ciphering the concatenated SDU based at least in part on the concatenated SDU being separate from the one or more SDAP headers; and transmitting, to a second wireless device, one or more messages comprising the PDU comprising the one or more SDAP headers and the ciphered concatenated SDU.

Aspect 2: The method of aspect 1, wherein the one or more SDAP headers are included as part of one or more respective concatenation headers of the PDU, and the one or more SDAP headers and the one or more respective concatenation headers are unciphered based at least in part on the concatenated SDU being separate from the one or more SDAP headers and the one or more respective concatenation headers.

Aspect 3: The method of aspect 1, wherein a first SDAP header of the one or more SDAP headers is adjacent to a first SDU of the plurality of SDUs and a second SDAP header of the one or more SDAP headers is adjacent to a second SDU of the plurality of SDUs, and the one or more SDAP headers are cyphered or uncyphered based at least in part on the ciphering of the concatenated SDU.

Aspect 4: The method of any of aspects 1 through 3, wherein the one or more SDAP headers comprise a SDAP control PDU, the method further comprising: outputting, to a concatenation buffer, the plurality of SDUs with the SDAP control PDU.

Aspect 5: The method of any of aspects 1 through 4, wherein the one or more SDAP headers comprise a SDAP control PDU, the method further comprising: outputting the SDAP control PDU for transmission to the second wireless device, wherein the SDAP control PDU is excluded from concatenation with the plurality of SDUs.

Aspect 6: The method of aspect 5, further comprising: skipping addition of the SDAP control PDU to concatenation buffer for obtaining the concatenated SDU; and applying the SDAP control PDU for transmission to the second wireless device after addition of a PDCP header.

Aspect 7: The method of any of aspects 1 through 4, wherein the one or more SDAP headers comprise a SDAP control PDU, the method further comprising: outputting the concatenated SDU from a concatenation buffer based at least in part on detecting the SDAP control PDU among the plurality of SDUs; and outputting, for transmission to the second wireless device, the SDAP control PDU with the plurality of SDUs of the concatenated SDU.

Aspect 8: The method of aspect 7, wherein outputting the concatenated SDU from the concatenation buffer comprises: outputting the concatenated SDU from the concatenation buffer irrespective of whether a quantity of the plurality of SDUs satisfies a threshold quantity, whether a concatenation timer is expired, or both, in response to detecting the SDAP control PDU.

Aspect 9: The method of any of aspects 1 through 8, wherein the one or more SDAP headers comprise a SDAP control PDU, the method further comprising: outputting the PDU for transmission to the second wireless device, wherein the SDAP control PDU is included as part of a respective concatenation header of the PDU, and wherein the SDAP control PDU and the respective concatenation header occur prior to the concatenated SDU.

Aspect 10: The method of aspect 9, wherein the respective concatenation header comprises a length field that indicates a payload size of the SDAP control PDU.

Aspect 11: The method of aspect 10, wherein the payload size comprising a value of zero indicates a presence of the SDAP control PDU.

Aspect 12: The method of any of aspects 1 through 11, wherein the PDU comprises a PDCP PDU, a PDCP control PDU, one or more ROHC PDUs, one or more EHC PDUs, or any combination thereof.

Aspect 13: A method for wireless communications, comprising: receiving a PDU comprising a first portion and a second portion, the first portion comprising one or more unciphered SDAP headers and the second portion comprising a ciphered concatenated SDU that includes a plurality of SDUs; and deciphering the second portion of the PDU based at least in part on the ciphered concatenated SDU being separate from the one or more unciphered SDAP headers.

Aspect 14: The method of aspect 13, wherein the one or more SDAP headers are included as part of one or more respective concatenation headers of the PDU, and the one or more SDAP headers and the one or more respective concatenation headers are unciphered based at least in part on the concatenated SDU being separate from the one or more SDAP headers and the one or more respective concatenation headers.

Aspect 15: The method of aspect 13, wherein a first SDAP header of the one or more SDAP headers is adjacent to a first SDU of the plurality of concatenated SDUs and a second SDAP header of the one or more SDAP headers is adjacent to a second SDU of the plurality of concatenated SDUs.

Aspect 16: The method of aspect 13, wherein the one or more unciphered SDAP headers each comprise an unciphered SDAP control PDU, and the unciphered SDAP control PDU is separate from the ciphered concatenated SDU.

Aspect 17: The method of aspect 16, wherein the unciphered SDAP control PDU is included as part of a respective concatenation header of the PDU, and the unciphered SDAP control PDU and the respective concatenation header occur prior to the plurality of ciphered concatenated SDUs.

Aspect 18: The method of aspect 17, wherein the respective concatenation header comprises a length field that indicates a payload size of the unciphered SDAP control PDU.

Aspect 19: The method of aspect 18, further comprising identifying a first unciphered SDAP control PDU based at least in part on a payload size of a first length field comprising a value of zero.

Aspect 20: The method of any of aspects 13 through 19, wherein the PDU comprises a PDCP PDU, a PDCP control PDU, one or more ROHC PDUs, one or more EHC PDUs, or any combination thereof.

Aspect 21: An apparatus for wireless communications, comprising one or more memories storing processor-executable code, and one or more processors coupled with the one or more memories and individually or collectively operable to execute the code to cause the apparatus to perform a method of any of aspects 1 through 12.

Aspect 22: An apparatus for wireless communications, comprising at least one means for performing a method of any of aspects 1 through 12.

Aspect 23: A non-transitory computer-readable medium storing code for wireless communications, the code comprising instructions executable by one or more processors to perform a method of any of aspects 1 through 12.

Aspect 24: An apparatus for wireless communications, comprising one or more memories storing processor-executable code, and one or more processors coupled with the one or more memories and individually or collectively operable to execute the code to cause the apparatus to perform a method of any of aspects 13 through 20.

Aspect 25: An apparatus for wireless communications, comprising at least one means for performing a method of any of aspects 13 through 20.

Aspect 26: A non-transitory computer-readable medium storing code for wireless communications, the code comprising instructions executable by one or more processors to perform a method of any of aspects 13 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
identify a first portion and a second portion of a protocol data unit, the first portion comprising one or more service data adaptation protocol headers and the second portion comprising a concatenated service data unit that includes a plurality of service data units;
cipher the concatenated service data unit based at least in part on the concatenated service data unit being separate from the one or more service data adaptation protocol headers; and
transmit, to a second wireless device, one or more messages comprising the protocol data unit comprising the one or more service data adaptation protocol headers and the ciphered concatenated service data unit.

2. The first wireless device of claim 1, wherein the one or more service data adaptation protocol headers are included as part of one or more respective concatenation headers of the protocol data unit, and the one or more service data adaptation protocol headers and the one or more respective concatenation headers are unciphered based at least in part on the concatenated service data unit being separate from the one or more service data adaptation protocol headers and the one or more respective concatenation headers.

3. The first wireless device of claim 1, wherein a first service data adaptation protocol header of the one or more service data adaptation protocol headers is adjacent to a first service data unit of the plurality of service data units and a second service data adaptation protocol header of the one or more service data adaptation protocol headers is adjacent to a second service data unit of the plurality of service data units, and the one or more service data adaptation protocol headers are ciphered or unciphered based at least in part on the ciphering of the concatenated service data unit.

4. The first wireless device of claim 1, wherein the one or more service data adaptation protocol headers comprise a service data adaptation protocol control protocol data unit, and the one or more processors are individually or collectively further operable to execute the code to cause the first wireless device to:
output, to a concatenation buffer, the plurality of service data units with the service data adaptation protocol control protocol data unit.

5. The first wireless device of claim 1, wherein the one or more service data adaptation protocol headers comprise a service data adaptation protocol control protocol data unit, and the one or more processors are individually or collectively further operable to execute the code to cause the first wireless device to:
output the service data adaptation protocol control protocol data unit for transmission to the second wireless device, wherein the service data adaptation protocol control protocol data unit is excluded from concatenation with the plurality of service data units.

6. The first wireless device of claim 5, wherein the one or more processors are individually or collectively further operable to execute the code to cause the first wireless device to:
skip addition of the service data adaptation protocol control protocol data unit to a concatenation buffer for obtaining the concatenated service data unit; and
apply the service data adaptation protocol control protocol data unit for transmission to the second wireless device after addition of a packet data convergence protocol header.

7. The first wireless device of claim 1, wherein the one or more service data adaptation protocol headers comprise a service data adaptation protocol control protocol data unit, and the one or more processors are individually or collectively further operable to execute the code to cause the first wireless device to:
output the concatenated service data unit from a concatenation buffer based at least in part on detecting the service data adaptation protocol control protocol data unit among the plurality of service data units; and
output, for transmission to the second wireless device, the service data adaptation protocol control protocol data unit with the plurality of service data units of the concatenated service data unit.

8. The first wireless device of claim 7, wherein, to output the concatenated service data unit from the concatenation buffer, the one or more processors are individually or collectively operable to execute the code to cause the first wireless device to:
output the concatenated service data unit from the concatenation buffer irrespective of whether a quantity of the plurality of service data units satisfies a threshold quantity, whether a concatenation timer is expired, or both, in response to detecting the service data adaptation protocol control protocol data unit.

9. The first wireless device of claim 1, wherein the one or more service data adaptation protocol headers comprise a service data adaptation protocol control protocol data unit, and the one or more processors are individually or collectively further operable to execute the code to cause the first wireless device to:
output the protocol data unit for transmission to the second wireless device, wherein the service data adaptation protocol control protocol data unit is included as part of a respective concatenation header of the protocol data unit, and wherein the service data adaptation protocol control protocol data unit and the respective concatenation header occur prior to the concatenated service data unit.

10. The first wireless device of claim 9, wherein the respective concatenation header comprises a length field that indicates a payload size of the service data adaptation protocol control protocol data unit.

11. The first wireless device of claim 10, wherein the payload size comprising a value of zero indicates a presence of the service data adaptation protocol control protocol data unit.

12. The first wireless device of claim 1, wherein the protocol data unit comprises a packet data convergence protocol (PDCP) protocol data unit, a PDCP control protocol data unit, one or more robust header compression (ROHC) protocol data units, one or more ethernet header compression (EHC) protocol data units, or any combination thereof.

13. A first wireless device, comprising:
one or more memories storing processor-executable code; and
one or more processors coupled with the one or more memories and individually or collectively operable to execute the code to cause the first wireless device to:
receive a protocol data unit comprising a first portion and a second portion, the first portion comprising one or more unciphered service data adaptation protocol headers and the second portion comprising a ciphered concatenated service data unit that includes a plurality of service data units; and
decipher the second portion of the protocol data unit based at least in part on the ciphered concatenated service data unit being separate from the one or more unciphered service data adaptation protocol headers.

14. The first wireless device of claim 13, wherein the one or more unciphered service data adaptation protocol headers are included as part of one or more respective concatenation headers of the protocol data unit, and the one or more unciphered service data adaptation protocol headers and the one or more respective concatenation headers are unciphered based at least in part on the concatenated service data unit being separate from the unciphered one or more service data adaptation protocol headers and the one or more respective concatenation headers.

15. The first wireless device of claim 13, wherein a first service data adaptation protocol header of the one or more unciphered service data adaptation protocol headers is adjacent to a first service data unit of the plurality of concatenated service data units and a second service data adaptation protocol header of the one or more unciphered service data adaptation protocol headers is adjacent to a second service data unit of the plurality of concatenated service data units.

16. The first wireless device of claim 13, wherein the one or more unciphered service data adaptation protocol headers each comprise an unciphered service data adaptation protocol control protocol data unit, and the unciphered service data adaptation protocol control protocol data unit is separate from the ciphered concatenated service data unit.

17. The first wireless device of claim 16, wherein the unciphered service data adaptation protocol control protocol data unit is included as part of a respective concatenation header of the protocol data unit, and the unciphered service data adaptation protocol control protocol data unit and the respective concatenation header occur prior to the plurality of ciphered concatenated service data units.

18. The first wireless device of claim 17, wherein the respective concatenation header comprises a length field that indicates a payload size of the unciphered service data adaptation protocol control protocol data unit.

19. The first wireless device of claim 18, wherein the one or more processors are individually or collectively further operable to execute the code to cause the first wireless device to:
identify a first unciphered service data adaptation protocol control protocol data unit based at least in part on a payload size of a first length field comprising a value of zero.

20. The first wireless device of claim 13, wherein the protocol data unit comprises a packet data convergence protocol (PDCP) protocol data unit, a PDCP control protocol data unit, one or more robust header compression (ROHC) protocol data units, one or more ethernet header compression (EHC) protocol data units, or any combination thereof.

21. A method for wireless communications by a first wireless device, comprising:
identifying a first portion and a second portion of a protocol data unit, the first portion comprising one or more service data adaptation protocol headers and the second portion comprising a concatenated service data unit that includes a plurality of service data units;
ciphering the concatenated service data unit based at least in part on the concatenated service data unit being separate from the one or more service data adaptation protocol headers; and
transmitting, to a second wireless device, one or more messages comprising the protocol data unit comprising the one or more service data adaptation protocol headers and the ciphered concatenated service data unit.

22. The method of claim 21, wherein the one or more service data adaptation protocol headers are included as part of one or more respective concatenation headers of the protocol data unit, and the one or more service data adaptation protocol headers and the one or more respective concatenation headers are unciphered based at least in part on the concatenated service data unit being separate from the one or more service data adaptation protocol headers and the one or more respective concatenation headers.

23. The method of claim 21, wherein a first service data adaptation protocol header of the one or more service data adaptation protocol headers is adjacent to a first service data unit of the plurality of service data units and a second service data adaptation protocol header of the one or more service data adaptation protocol headers is adjacent to a second service data unit of the plurality of service data units, and the one or more service data adaptation protocol headers are ciphered or unciphered based at least in part on the ciphering of the concatenated service data unit.

24. The method of claim 21, wherein the one or more service data adaptation protocol headers comprise a service data adaptation protocol control protocol data unit, the method further comprising:
outputting, to a concatenation buffer, the plurality of service data units with the service data adaptation protocol control protocol data unit.

25. The method of claim 21, wherein the one or more service data adaptation protocol headers comprise a service data adaptation protocol control protocol data unit, the method further comprising:
outputting the service data adaptation protocol control protocol data unit for transmission to the second wireless device, wherein the service data adaptation protocol control protocol data unit is excluded from concatenation with the plurality of service data units.

26. The method of claim 25, further comprising:
skipping addition of the service data adaptation protocol control protocol data unit to a concatenation buffer for obtaining the concatenated service data unit; and
applying the service data adaptation protocol control protocol data unit for transmission to the second wireless device after addition of a packet data convergence protocol header.

27. The method of claim 21, wherein the one or more service data adaptation protocol headers comprise a service data adaptation protocol control protocol data unit, the method further comprising:
outputting the concatenated service data unit from a concatenation buffer based at least in part on detecting the service data adaptation protocol control protocol data unit among the plurality of service data units; and
outputting, for transmission to the second wireless device, the service data adaptation protocol control protocol data unit with the plurality of service data units of the concatenated service data unit.

28. The method of claim 27, wherein outputting the concatenated service data unit from the concatenation buffer comprises:
outputting the concatenated service data unit from the concatenation buffer irrespective of whether a quantity of the plurality of service data units satisfies a threshold quantity, whether a concatenation timer is expired, or both, in response to detecting the service data adaptation protocol control protocol data unit.

29. The method of claim 21, wherein the one or more service data adaptation protocol headers comprise a service data adaptation protocol control protocol data unit, the method further comprising:
outputting the protocol data unit for transmission to the second wireless device, wherein the service data adaptation protocol control protocol data unit is included as part of a respective concatenation header of the protocol data unit, and wherein the service data adaptation protocol control protocol data unit and the respective concatenation header occur prior to the concatenated service data unit.

30. A method for wireless communications by a first wireless device, comprising:
receiving a protocol data unit comprising a first portion and a second portion, the first portion comprising one or more unciphered service data adaptation protocol headers and the second portion comprising a ciphered concatenated service data unit that includes a plurality of service data units; and
deciphering the second portion of the protocol data unit based at least in part on the ciphered concatenated service data unit being separate from the one or more unciphered service data adaptation protocol headers.
